(19) United States
(12) Patent Application Publication
(10) Pub. No.: US 2005/0015233 A1
(43) Pub. Date: Jan. 20, 2005

(54) Method for computing partially coherent aerial imagery

(75) Inventor: Ronald L. Gordon, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 10/621,472

(22) Filed: Jul. 17, 2003

(51) Int. Cl. G06F 17/50; G06G 7/62

(52) U.S. Cl. 703/13; 716/19

(57) ABSTRACT

A method for simulating aerial images is provided where the integrand of a transmission cross-coefficient (TCC) integral is formed from defocused paraxial pupil transfer functions, and contour integration is performed over the boundary of the intersection of the offset pupil functions and the source function. Preferably, the paraxial pupil functions are approximated by a second order Taylor series expansion. The integrand is preferably parameterized in terms of the angles subtending the arcs of the boundary of the integration region, and the integrand is further approximated by an expansion of analytically integrable terms having an error term that substantially monotically decreases as the number of expansion terms increases. Additional factors such as aberrations and amplitude variations can be included by using functions that are simply multipied with the defocused paraxial pupil functions in the integrand. The integrands provide fast computations of TCC integrals that are accurate to within a desired tolerance.

### TECHNICAL FIELD

The present invention relates in general to manufacturing processes that require lithography and, in particular, to methods of designing photomasks and optimizing lithographic and etch processes used in microelectronics manufacturing.

### BACKGROUND INFORMATION

During microelectronics manufacturing, a semiconductor wafer is processed through a series of tools that perform lithographic processing, followed by etch processing, to form features and devices in the substrate of the wafer. Such processing has a broad range of industrial applications, including the manufacture of semiconductors, flat-panel displays, micromachines, and disk heads.

The lithographic process allows for a mask or reticle pattern to be transferred via spatially modulated light (the aerial image) to a photoresist (hereinafter, also referred to interchangeably as resist) film on a substrate. Those segments of the absorbed aerial image, whose energy (so-called actinic energy) exceeds a threshold energy of chemical bonds in the photoactive component (PAC) of the photoresist material, create a latent image in the resist. In some resist systems the latent image is formed directly by the PAC; in others (so-called acid catalyzed photoresists), the photo-chemical interaction first generates acids which react with other photoresist components during a post-exposure bake to form the latent image. In either case, the latent image marks the volume of resist material that either is removed during the development process (in the case of positive photoresist) or remains after development (in the case of negative photoresist) to create a three-dimensional pattern in the resist film. In subsequent etch processing, the resulting resist film pattern is used to transfer the patterned openings in the resist to form an etched pattern in the underlying substrate.

Diffraction, interference and processing effects that occur during the transfer of the image pattern causes the image or pattern formed at the substrate to deviate from the desired (i.e. designed) dimensions and shapes. These deviations depend on the interaction of the pattern configurations with the process conditions, and can affect the yield and performance of the resulting microelectronic devices. Various techniques have been used to compensate for and correct for these deviations. Such techniques include known as optical proximity correction (OPC), for example, by biasing selected mask features to compensate for deviations. Other techniques include using sub-resolution assist features (SRAFs), also known as scattering bars or intensity leveling bars, to improve the uniformity of grating characteristics of the mask, and thereby improve optimization of lithographic process conditions for the mask. Phase shifted mask technology (PSM) has also been used to improve the contrast of image features by destructive interference, and thus improve resolution. These and other various techniques for improving the lithographic process are generally referred to as resolution enhancement techniques (RETs).

Prediction of the partially coherent images resulting from illumination in a modern lithographic scanner is of paramount importance as looming technology nodes stress the use of Resolution Enhancement Technologies (RETs), such as SubResolution Assist Features (SRAFs) and Alternating Phase-Shift Masks (AltPSM). Without fast and accurate simulation, it would be impossible to employ an strong RET solution in a practical setting. The reason for this is because simulations have made the transition from learning/research tool to a major ingredient in the design stage. However, in practice, only a portion of a mask pattern can be simulated at a time, to allow for reasonable computation times.

The ability to accurately predict the resulting aerial image, latent image and/or etched pattern due to the lithographic and etch processes is crucial for ensuring sufficient manufacturing yields and reducing costs of manufacturing. The aerial image of a mask pattern is the distribution of intensity at the plane of the wafer or resist surface. The accurate simulation of the aerial image is key in the design of photomasks, for example, by model-based optical proximity correction (model-based OPC). In model-based OPC, for given lithographic process conditions (e.g. illumination source parameters, numerical aperture (NA) and partial coherence (σ₀) of the lithography tool, specified exposure dose and defocus, etc.), and an initial mask design, the resulting image is simulated. In the model-based OPC process, the simulated image is compared to the target (desired) design, and deviations from the desired image are determined. The mask design is iteratively modified until the simulated image agrees with the target design within an acceptable tolerance. Thus the accuracy of the simulated image is crucial in obtaining viable mask designs, and the speed of such calculations impacts the cost of designing the masks.

Simulated images can also be used to improve understanding the interaction of, and for optimizing the lithographic process conditions to maximize resolution and improve yields. For example, for a particular design pattern, a decision to use one type of resolution enhancement technique over another, for example, whether to use altPSM or SRAFs involves an understanding what the best range of process windows will be for a range of altPSM or SRAF processes. A wide range of process conditions must be simulated and corresponding images simulated for each process condition, at a required accuracy. The simulation of a single aerial image using conventional methods, with sufficient accuracy (e.g. within 1%), typically takes hours or even days.

To get an idea of what sort of accuracy is required in simulation, consider that the aerial image simulator can be viewed as a metrology tool. There is an inherent uncertainty in metrology, for example in using metrology techniques such as (scanning electron microscope) SEM, in which a target to be measured is bombarded with electrons, which in turn produce a signal, indicating, for example, line widths in the target. However, there is an inherent uncertainty in these measurements, for example, caused by charge damage to features on the target. The precision to tolerance ratio (P to T ratio) is the ratio of the precision, or accuracy, of the metrology tool to the tolerance specification for the device being measured. The specification for line widths (CD) may be, for example, 90 nm, within 3 sigma. The demand on the line width distribution is such that CD has a mean value of 90 nm, wherein the 3 sigma variation is within 5% of 90 nm (e.g. ±4.5 nm tolerance). A typical spec for P-T ratio is to measure the line within a small fraction of 4.5 nm (e.g. 20% or 0.90 nm or 9.0 Angstroms). A simulation tool should provide numerical accuracy in a similar vein as the metrology tools specifications, e.g. within 0.90 nm. One conventional method of simulating aerial images is to use a gridding algorithm, as in the prior art outlined above, but in order to obtain the precisions required, to obtain the required precision, the smaller grid sizes result in a large number of gridding intervals, which in turn result in impractical computation times. Such gridding methods cannot be used to simulate large portions of a mask in a practical amount of time.

Partially coherent imagery is simulated using what is now called the Hopkins Model (see, H. H. Hopkins, “On the diffraction theory of optical images,” Proc. of the Royal Society of London, Vol. A 217, pp. 408-432 (1953)). The Hopkins model for simulating the aerial image is a method to compute aerial images using the frequency space information of the optical system. In doing this, the calculation can be split into two independent steps. Here, the intensity, defined as the average of the square magnitudes of the electric fields that emanate from each point in the illumination source, is expressed as a quadratic form in the mask spectrum—which is the Fourier transform (in the spatial frequency domain) of the mask transmittance—multiplied by a matrix of complex numbers called Transmission Cross-Coefficients (TCCs), which takes into account the source (illumination shape) and pupil (aberrations, defocus, vector, obliquity) information. The TCCs are autocorrelations of the transfer function of the pupil (henceforth called the “pupil function”) weighted by the spatial Fourier transform of the illumination source (referred to hereinafter as the “source function”). The pupil is the image of the limiting stop, or aperture, in an optical system, but for the present purposes, the entrance/exit pupils represent the input/output planes for the optical system. These autocorrelations are, in general, double integrals over a very complicated region defined by the intersection of the pair of frequency-offset pupils and the source. Because of the complexity of the shape of this region, computation of these TCCs is potentially expensive.

The second step is the computation of the mask spectrum (or, Fourier transform of the mask, referred to hereinafter as the “mask function”). This can be computed analytically for most, if not all, one-dimensional masks in lithography. An analytical computation of the Fourier transform for all two-dimensional shapes can be obtained, for example, by the method disclosed in U.S. patent application Ser. No. 10/353,900, which is commonly assigned to the Assignee of the present application. This analytical calculation, while exact, tends to be expensive compared with the decomposition techniques in the SOCS method, because each edge required a trigonometric function evaluation. Nevertheless, such a calculation leaves little doubt as to the overall accuracy of the computation.

A major simplification is typically made by assuming that the portion of the mask to be simulated is periodic. This is because the spectrum of periodic gratings is nonzero at a discrete number of frequencies, meaning that the frequencies that have nonzero TCCs lie on a regular, discrete grid in spatial frequency space. This periodic assumption is used by all current lithography simulators, since rigorous image computation over an entire (26 MM)² field is impractical. This, of course, is an approximation in itself, as real circuitry to be manufactured will not necessarily possess this periodic property. Nevertheless, a single local set of shapes in a region of interest, or cell, of any size can be simulated with great accuracy from the periodic assumption. The reason for this is that optical diffraction phenomena have a range of Cλ/(NAσ₀), where NA is the numerical aperture, λ is the wavelength, σ₀ is the partial coherence (or pupil-fill), and C is a constant equal to about at most 10 (for example, see Wong et al., U.S. Pat. No. 6,223,139). Therefore, there is a finite range of influence, beyond which features have no impact on the desired pattern. Thus, if ones assumes periodicity (or any other boundary condition) for a unit cell of the nominal pattern size plus this influence range, then the simulated image inside the unit cell can be considered exact for all practical purposes.

With the mask periodic and the spectrum discrete, the set of TCCs to be evaluated is therefore discrete and finite in number. In general, they fill a four-dimensional matrix, and it can be shown that the number of TCCs needed for computation varies as the square of the area of the unit cell—in other words, as the fourth power of the length of a nearly square cell. Therefore, even with this simplification, the number of difficult, double integrals that are needed to accurately define the image becomes unmanageable for even moderately large (<10 μm² area) cells.

In all current lithography simulation software, the TCCs are currently computed by gridding the source and pupil for a numerical integration. This gridding can be sophisticated: for example, in the software SPLAT (see K. K. H. Toh and A. Neureuther, “Identifying and Monitoring Effects of Lens Aberrations in Projection Printing,” SPIE, Vol. 772, pp. 202-209, Optical Microlithography VI: 4-5 Mar. 1987, Santa Clara, Calif.), a fixed grid is used in one direction, while an adaptive grid (it refines until a certain tolerance is reached) is used in another. In order to achieve this, the integration limits of the integration region must be computed. This allows for greater accuracy in computing aberrated images, for example. Unfortunately, because of the adaptive stepping in the integration, the algorithm runs as long as it needs in order to achieve a certain accuracy. This can take a long time, especially with pupils that have large phase variations, such as in large defocus and/or aberrations.

The problem of providing fast simulation has already been attacked though the use of the so-called “Sum of Coherent Systems” (SOCS) method detailed in N. Cobb and A. Zakhor, “Fast low-complexity mask design”, Proc. SPIE, Vol. 3334, pp. 313-327 (1995). This method expresses the intensity as a sum over the squares of convolutions of the mask transmittance function with coherent point spread functions, or kernels; these kernels are inverse Fourier transforms of the eigenfunctions of the TCC matrix. By expressing the mask in terms of a discrete set of elements, these convolutions can be precomputed and stored in a database. This allows for very rapid image computation that is crucial for model-based OPC (MBOPC). There are caveats with this SOCS methodology, however. First of all, the sum used must be finite (and is typically between 8 and 12 terms), whereas the exact expression involves an infinite number of terms; typical accuracy estimates from using the finite series for the aerial image intensity are between 80 and 90%, with a relatively slow rate of convergence. While this may suffice for past generations with a larger error tolerance (that is, the larger allowed linewidth variation could accept larger simulation errors, as noted above), this will not serve the future generations, where the error tolerances are rapidly vanishing.

Second, these kernels, are eigenfunctions of a matrix operator defined by the TCCs. In order to compute these eigenfunctions, the TCCs must be computed. Since the TCCs are independent of the mask function, these TCCs will be computed only once, whereas the intensity is computed thousands of times. This is true if only the mask features (and not the parameters of the projection system) are to be varied during a MBOPC session. It turns out, however, that the task of calibration of a model to data has gotten so difficult that some physical parameters that are known to be in error—such as the partial coherence or focus—are varied as well. The fitting of these physical parameters demands recomputation of the TCCs, so the ability to compute them very quickly is crucial here.

There is a method of computing the TCC matrix rapidly due to Liebchen (U.S. patent application Pub. No. US 2002/0062206 A1). Here, the TCC matrix itself is approximated as a bilinear form η^{T}Aη, where η is a vector of orthonormal Hermite-Gaussian terms, and A is a Hermitian matrix. The benefit of doing this is that the size of the TCC matrix can be reduced substantially, making changes with respect to optical parameters such as the numerical aperture or defocus very fast. While this certainly has resulted in a significant increase in computational speed, it is not obvious what accuracy of the image intensity that this method produces, as not only the pupil and source are evaluated on a grid and numerical integration is necessary on at least one dimension, but the expression of the TCC matrix in this orthogonal basis is only exact when an infinite number of terms are used.

Accuracy is crucial, and although few have ever questioned the half-century-old theory of optical image formation via partially coherent Kohler illumination (despite the scant experimental verifications of the various parametric dependencies, especially those relating to “obliquity factors” which are generally considered to have small impact), numerical accuracy in proprietary software has always been a concern. Many benchmarking projects have been performed, but most have been simple numerical checks between software. Speed is also a major issue, because many thousands of simulations must take place in order to perform a single optimization. Historically, there has always been a tradeoff between speed and accuracy, in that speed requires one to sample less source integration points, or less eigenfunction kernels in the “fast” algorithms used in Model-Based OPC software. On the other hand, analytical solutions, if they exist, solve the speed/accuracy issue, since all the computation time comes from the numerous double integrations required for the image computation. If one were to replace the double integrations (thousands of function evaluations) with a single function evaluation, then the speed of the algorithm would increase many times over, and the accuracy would be to machine precision. The trouble is, of course, finding such a solution.

Rigorous analytical methods of aerial images would be preferred to the numerical gridding methods commonly in use today, but are typically impractical because the resulting integrals cannot directly be evaluated in many cases. However, such analytical methods have been available for computing aerial images in special cases. The simplest case of this was illustrated by Kintner (Kintner, Eric C., “Method for the calculation of partially coherent imagery,” Applied Optics, Vol. 17, No. 17, pp. 2747-2757, Sep. 1, 1978) for simulation of in-focus, partially coherent images of one-dimensional (1D) gratings. By considering all of the possible geometrical configurations of the TCCs in 1D (i.e., along the x-axis), Kintner was able to compute the exact value of the TCCs due to the fact that these values are equal to the area of a region bounded by 3 circles, all of whose centers are collinear. While this was a useful first step, the important cases of more general patterns seen in lithography were untreated, as well as the ability to compute defocus effects.

Going one step further, Subramanian (Subramanian, S., “Rapid calculation of defocused partially coherent images,” Applied Optics, Vol. 20, No. 10, pp. 1854-1857, May 15, 1981) considered the simulation of defocused images of the one-dimensional (1D) gratings. Here, Kintner's work was built upon by finding the integration limits within each geometrical configuration. In the paraxial (i.e., small numerical aperture, with NA≦0.4) approximation, the defocus term could be integrated analytically in one dimension, while numerical integration was used for the other. While this extended the art significantly, it is still limited to one-dimensional (1D) gratings and small values of the numerical aperture.

The method outlined by Liebchen takes the approach of decomposing these TCCs (i.e. representing the TCC matrix as a bilinear Hermite-Gaussian expansion). While Liebchen's method does potentially reduce the number of TCCs needed, it also introduces a gridding; the combination of the decomposition and gridding methodologies introduce potential inaccuracies. Further, it is unclear how large values of defocus or aberrations are treated with any accuracy, as all treatments are Taylor expansions of the phases in the frequency variable. For small aberrations, this is acceptable, but such expansions quickly lose accuracy in the face of even a moderate defocus

Therefore, there is a need to compute the TCCs without recourse to grids or orthogonal basis decompositions so that accuracy is maintained, or at least monitored, while the speed needed to computed moderately large patterns is satisfied.

### SUMMARY OF THE INVENTION

It is an objective of the present invention to provide a method for obtaining solely analytical expressions for all of the TCC integrals. A further objective of the present invention is to provide an approximate analytical representation for the TCCs that is accurate to within a desired small error, for example, within the precision of a given computer, which is typically on the order of about 10⁶ for typical single precision calculations in current machines. It is yet a further objective of the present invention to provide a method for computing aerial images very rapidly compared to conventional numerical integration techniques, and to within a desired accuracy, for example very close to machine precision. That is, a primary objective of the present invention is to eliminate the tradeoff between speed and accuracy in the simulation of aerial images, achieving both simultaneously.

In accordance with the present invention, an analytical solution for the TCC integral has been derived. For the in-focus, aberration-free case, the analytical solution is exact, using only a single arctangent and at most 4 square roots per transmission cross-coefficient (TCC). This solution has been extended to defocus and small aberrations, and has been implemented in computer code.

The invention takes advantage of two facts concerning the TCCs: 1) The integration region of the TCCs is bounded by circular arcs for circular-shaped sources and pupils; and 2) the integrand of the TCC expression can be represented by a simple, linear phase for the case of a defocused pupil in the paraxial approximation. These facts, combined with the application of Stokes' Theorem (a basic theorem of integral calculus) results in a reduction of the double integral to a single integral for any arbitrary 2D pattern.

In a further aspect of the present invention, the TCC integration regions are characterized all in terms of a finite set of all the possible geometrical configurations, based on a rotational alignment of the spatial coordinate axis with the axis of symmetry of the integration region. These regions change shape as the spatial frequencies vary, as do the integration limits over which the integrand is to be evaluated. It turns out that there are 18 distinct geometrical configurations when the double integral is used. Furthermore, when Stokes' Theorem is applied, only the boundary of these geometric configurations are considered, and it turns out that the number of distinct configurations is reduced to 9. Such a reduction simplifies the program logic and speeds up calculations.

In a further aspect of the present invention, all of the integrals over the various arcs that comprise the boundaries of the finite geometrical regions is reduced to the same integral form. Since this particular integral does not have an exact representation in terms of purely analytical functions, the present invention provides an approximation for the integrand that differs from the original function in absolute value by a desired small number, for example, on the order of single precision over all possible values of the integration limits. In accordance with the present invention, this new function is chosen such that the error substantially monotonically decreases as the number of terms used in the approximation increases. Furthermore, the integral of the terms of the approximate function is representable in terms of analytical functions that can be computed with a few arithmetic steps. Therefore, the present invention permits computation of a TCC that is accurate to within a desired precision and can be evaluated rapidly using a finite number of arithmetic operations.

In yet another aspect of the present invention, a computation of the partially coherent, defocused imagery of an arbitrary pattern in the paraxial approximation is provided in which the image intensity is represented purely in terms of analytical functions that is accurate to within a desired precision.

The present invention further provides an expression for nonparaxial defocus imagery, in which an analytical expression for the nonparaxial defocus image is obtained by resealing the coordinates of the paraxial defocused field. Again, this can be achieved to within a desired precision. Therefore, the inventive method can be extended to higher values of the NA with no additional computational effort and only a small, but known, increase in the overall error.

In another aspect of the present invention, aberrations are included by providing an analytical expression for an aberration pupil function by computing a Taylor expansion of the phase difference between the nonparaxial and paraxial phases. Each term in this expansion corresponds to a higher-order correction that is represented as a derivative of the paraxial result. With some additional computation depending on the precision desired, a pupil function including aberrations can be obtained by multiplying the inventive analytical paraxial defocus pupil function by the analytical aberration pupil function obtained using the Taylor expansion. This method is extendable to other phase errors that are described by the aberrations that may be present in a stepper. These aberrations are typically high-order polynomials in the frequency coordinate, and the coefficients are typically small—on the order of a few hundredths of a wavelength. Therefore, Taylor expansion is a natural way to extend this analytic methodology in the case of small aberrations.

In yet another aspect of the present invention, the effects of amplitude variation across the pupil can be included. Such amplitude variations may become significant at higher values of the NA. These amplitude variations, or apodizations, come from energy conservation and vector effects that are not significant in the paraxial approximation. In accordance with the present invention, these apodization effects are also represented by approximated successively more accurately via an expansions, and the resulting amplitude effects are provided simply as multiplicative factors to the inventive paraxial defocused pupil function.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic diagram illustrating a projection illumination (e.g. Kohler) system.

FIG. 2 illustrates a diagram of source and pupil functions plotted in spatial frequency coordinates, including the TCC integration region.

FIG. 3 is an illustration of a region of a mask pattern for which an image is to be simulated.

FIGS. 4A-4D illustrate the four geometrical configurations for TCC integration regions for the case of a one-dimensional (1D) mask pattern.

FIGS. 5A-5B illustrate a rotation of the coordinate system along the symmetry axis of the TCC integration region.

FIGS. 6A-6R illustrate the 18 geometrical configurations for TCC integration regions for the case of a two-dimensional (2D) mask pattern.

FIG. 7 illustrates the angles corresponding to the endpoints of the arcs defining the TCC integration region used in the contour integration in accordance with the present invention.

FIG. 8 illustrates a plot of the error for a curve fit to the function \sqrt{1−w²}.

FIG. 9 illustrates a plot of the error for an approximation of an integral used in computing TCCs according to the present invention.

FIG. 10 illustrates a schematic diagram of a computer system capable of implementing the method of the present invention.

FIG. 11 is a flow diagram illustrating a conventional method of computing an aerial image according to the Hopkins model.

FIG. 12 illustrates a flow chart of a conventional method of computing TCCs.

FIG. 13 illustrates a flow chart of an embodiment for computing TCCs in accordance with the present invention.

### DETAILED DESCRIPTION

In the following description, numerous specific details may be set forth to provide a thorough understanding of the present invention. However, it will be obvious to those skilled in the art that the present invention may be practiced without such specific details. In other instances, well-known features may have been shown in block diagram form in order not to obscure the present invention in unnecessary detail.

Refer now to the drawings wherein depicted elements are not necessarily shown to scale and wherein like or similar elements are designated by the same reference numeral through the several views.

In accordance with the present invention, a fast, accurate analytical method for computing estimated aerial images, computed to within a desired tolerance. In accordance with the present invention, error estimates for the image computations are provided. The method of the present invention can incorporate aberrations.

The source is assumed to be circular, preferably having a step function intensity. Alternatively, more general intensity distributions may be used, such as a Gaussian distribution. In addition, the pupil is assumed to be circular. The lens aberrations are assumed to be small (e.g. tens of milliwaves), or zero.

The aerial image intensity is determined according to the Hopkins model for an image projected by a given mask that is illuminated in a Kohler illumination (projection) system using a given set of illumination conditions. The illumination conditions are characterized by a source shape (S), a pupil function (P) and the mask pattern (M) expressed in spatial frequency coordinates. The Hopkins model assumes linear, shift-invariance of the optical system. This means two things: 1) (linearity) each distinct temporal frequency is unchanged by the system; and 2) (shift-invariance) each off-axis plane wave input into the system does not change the shape of the spectrum, but merely shifts it by some amount that depends on the angle of propagation.

The following discussion is presented in order to provide a thorough understanding of the present invention, with specific examples presented as preferred embodiments.

1. General Theory

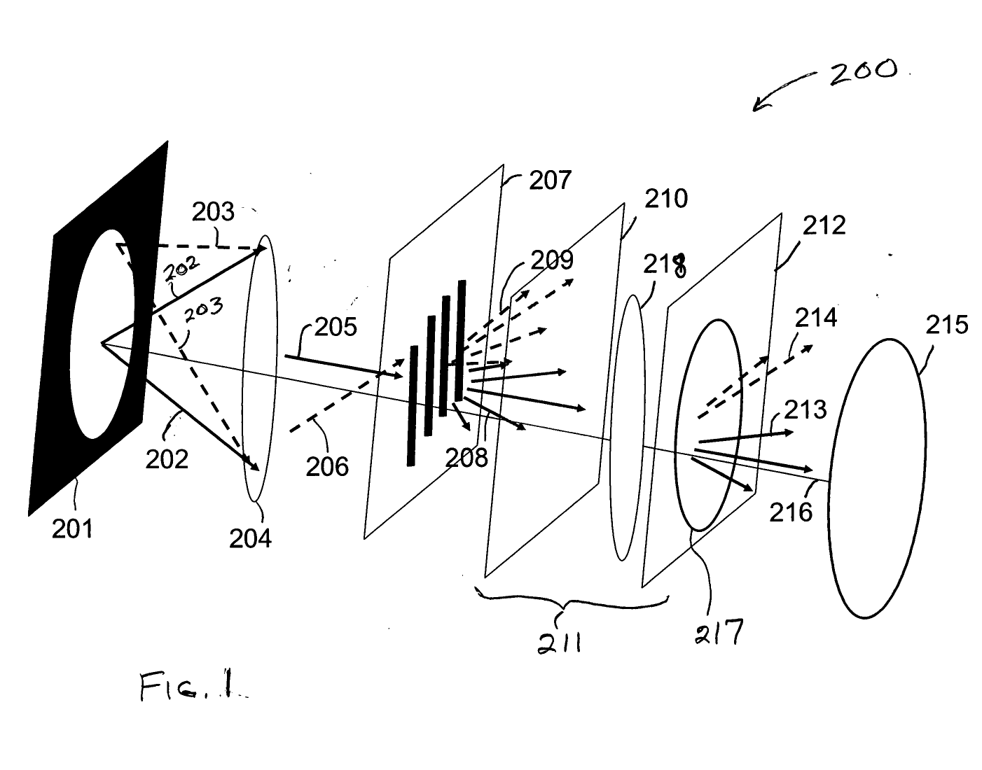

Consider a modern microlithographic imaging system 200 (generally known as a Köhler illumination system) as illustrated in FIG. 1, comprised of a (finite) source 201, condenser optics 204, a semitransparent mask 207 to be imaged, objective optics 211 having an entrance pupil 210, an exit pupil 212 and projection lens optics 218 (which typically includes multiple lenses) and a target, such as a silicon wafer in the image plane 215. In an ideal system, the source 201 may be represented by point sources, each of which emits light rays, including on-axis rays 202 from the center of the source and off-axis rays emitted from an source point off of the optical axis 216. The on-axis rays correspond to a perfectly coherent source. A condenser lens 204 collects energy from the source and redirects the light rays (e.g. from the center of the source 205 and off-axis rays 206) towards a mask 207 to be imaged. The on-axis and off-axis rays 208, 209 diffracted by the mask 207 are then collected by the entrance pupil 210 (i.e. the effective input plane) of the objective lens 211, is projected through the projection optics 218 and projects the mask image through the exit pupil 212 (i.e. the effective output plane) having an aperture 217 to form an aerial image at the target plane 215. Note that the aperture 217 of the exit pupil 212, is typically a circle that filters out those light rays whose angle with respect to the optical axis 216 is larger than the quantity sin^{-‘}NA. The idea here is that each point of the source 201 is then mapped onto a unique plane wave, incident at some angle upon the mask 207. Further, a uniform source is mapped onto a uniform distribution of plane wave amplitudes upon the mask. The light that is transmitted through the projection optics 211 is partially coherent.

The coherent electric field E at the point x (wherein the bold notation x and the notation \vec{x} both refer equivalently to a vector quantity, hereinafter) on the wafer or image plane 215, due to the on-axis source point only, is given by the following expression:

$$E ( x ) = {\int }_{{ℜ}^{2}} {ⅆ}^{2} u M ( u ) P ( u ) exp ( - ⅈ2π \frac{N A}{λ} u \cdot x ) , \qquad ( 1 )$$

where M represents the spatial Fourier transform of the mask transmittance function, or frequency response of the mask 207 (i.e., the mask function), P represents the pupil function, or frequency response of the objective optics 211, NA is the numerical aperture of the objective lens at the exit pupil 217, and λ is the illumination wavelength. R² represents all of two-dimensional space. The vector quantity u represents a scaled frequency coordinate in which the pupil function P is zero when |u|>1. For an off-axis incident plane wave, the expression for the electric field due to a single source at the off-axis scaled source coordinate σ becomes the following:

$$E ( x , σ ) = {\int }_{{ℜ}^{2}} {ⅆ}^{2} u M ( u - σ ) P ( u ) exp ( - ⅈ2π \frac{N A}{λ} u \cdot x ) . \qquad ( 2 )$$

The vector quantity NAσ represents the projection of a point on the unit sphere onto the mask plane 215, and in a Kohler illumination system, NA corresponds to the numerical aperture, and a represents a point in the illuminator 201, where the maximum magnitude of the vector σ is equal to the ratio of the NA of the condenser lens to the NA of the projector lens. This ratio is called the partial coherence factor σ₀ of the projection system 200.

To simulate the effects of a partially coherent Kohler illumination system on the electric field intensity, the off-axis intensity is averaged over all of the plane waves generated by the illuminator. (Note that the use of partially coherent illumination represents both reality, as no illumination system can be perfectly spatially coherent, and desireability, as the shape of the illumination can be varied to achieve, say, optimum process latitude.) If it is assumed that the intensity is proportional to the square magnitude of the electric field distribution, then the intensity at a point x on the image plane 215 is modeled to take the form

$$I ( x ) = \frac{{\int }_{{ℜ}^{2}} {ⅆ}^{2} σ S ( σ ) {\vert E ( x , σ ) \vert}^{2}}{{\int }_{{ℜ}^{2}} {ⅆ}^{2} σ S ( σ )} , \qquad ( 3 )$$

where S is the source distribution for the illumination system. That is, as mentioned above, the intensity at the image plane is an average of the intensities emanating from the fields generated by the various point sources that comprise the illuminator. Substituting Eq. (2) into Eq. (3), the following expression for electric field intensity results:

$$I ( x ) = {\int }_{{ℜ}^{2}} {ⅆ}^{2} {u}^{′} {\int }_{{ℜ}^{2}} {ⅆ}^{2} {u}^{″} M ( {u}^{′} ) T ( {u}^{′} , {u}^{″} ) {M}^{*} ( {u}^{″} ) exp [ - ⅈ2π \frac{N A}{λ} ( {u}^{′} - {u}^{″} ) \cdot x ] , \qquad ( 4 )$$

where the transmission cross-coefficient T (also referred to as the TCC or TCC integral) is given by

$$T ( {u}^{′} , {u}^{″} ) = {\int }_{{ℜ}^{2}} {ⅆ}^{2} σ S ( σ ) P ( {u}^{′} + σ ) {P}^{*} ( {u}^{″} + σ ) . \qquad ( 5 )$$

In the integrand in Eq. (5), the two pupils functions P(u′+σ), P(u″+σ) will henceforth be referred to as the “offset pupils”. The pupil function and source distribution function has finite support; that is, |u|>1 [symbol] P(u)=0 and |u|>σₘₐₓz,1 S(u)=0, due to the finite extent of the source and pupil apertures. This reduces the infinite integration interval specified in Eq. (5) into a finite interval, as shown in FIG. 2.

FIG. 2 illustrates the regions of integration for the TCC integral of Equation (5), plotted in spatial frequency source coordinate space, where the coordinates (σₓ,σ_{y}), are relative to the center of the source function S(σ). Note that the source distribution function S(σ) has a radius equal to the partial coherence factor σ₀, and has a value that is zero outside of the boundary 404 where |σ|>σ₀. The two offset pupil functions P(u′+σ), P(u″+σ) are represented by circles of unit radius 401, 402 respectively, having centers offset from the center of the source function (referred to hereinafter, for convenience, interchangeably as the source) by the vector quantities −u′, −u″, respectively. As discussed above, the offset pupil functions (referred to hereinafter, for convenience, interchageably as the pupils) take the value zero outside the boundaries 401, 402. The two non-zero offset pupil functions (or pupils) have an intersection region 403. The region of integration 405 for the TCC integral of Equation (5) is the intersection of the nonzero source function 404 and the intersection 403 of the offset pupil functions 401, 402.

2. Periodic Objects

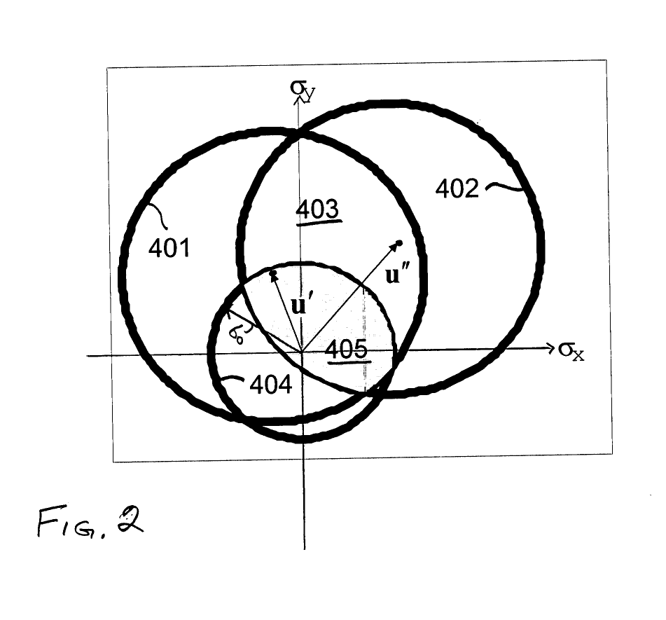

As discussed above, in the Hopkins model, a simplifying assumption often made is that the mask 207, or a portion thereof, such as a local set of shapes, referred to as a cell, is considered to be a periodic object. The preferred embodiment of the present invention also makes use of this periodic assumption. Referring to FIG. 3, consider a semitransparent, periodic object 300 comprising cells 302, 303, 304 that are repetitions of a mask cell 301 with x- and y-periods pₓ and p_{y}, respectively. Such an periodic mask 300 may be represented mathematically as a Fourier series:

$$M ( u ) = {\sum }_{m = - ∞}^{∞} {\sum }_{n = - ∞}^{∞} {c}_{mn} δ ( {u}_{x} - \frac{m}{{p}_{x}} \frac{λ}{N A} ) δ ( {u}_{y} - \frac{n}{{p}_{y}} \frac{λ}{N A} ) , \qquad ( 6 )$$

where the cₘₙ are the mask Fourier coefficients. The indices m and n will represent the various orders, or directions, into which the mask pattern 300 will split incoming light. Of course, the entire spectrum is not used in determining the image, as the objective lens 211 filters out the higher orders. When the mask function M of Eq. (6) is substituted into the image intensity of Eq. (4), a series for the intensity results:

$$I ( x ) = {\sum }_{{m}^{′} = - ∞}^{∞} {\sum }_{{m}^{″} = - ∞}^{∞} {\sum }_{{n}^{′} = - ∞}^{∞} {\sum }_{{n}^{″} = - ∞}^{∞} {c}_{{m}^{′} {n}^{′}} {c}_{{m}^{″} {n}^{″}}^{*} {T}_{{m}^{′} {n}^{′} {m}^{″} {n}^{″}} exp \{ - ⅈ2π [ ( {m}^{′} - {m}^{″} ) \frac{x}{{p}_{x}} + ( {n}^{′} - {n}^{″} ) \frac{y}{{P}_{y}} ] \} , \qquad ( 7 )$$

where the TCC integrals are evaluated at discrete lattice points due to the periodic assumption, and can be written as:

$${T}_{{m}^{′} {n}^{′} {m}^{″} {n}^{″}} = T ( \frac{{m}^{′}}{{q}_{x}} , \frac{{n}^{′}}{{q}_{y}} , \frac{{m}^{″}}{{q}_{x}} , \frac{{n}^{″}}{{q}_{y}} ) , \qquad ( 8 )$$

where the quantity q=pNA/λ. The discrete lattice points, where the TCC integrals T_{m′n′m″n″} are evaluated, are spaced at intervals of Δuₓ=1/qₓ and Δu_{y}=1/q_{y}. In principle, one could sum Eq. (7) directly, as the quantity T_{m′n′m″n″} is bound to vanish when the indices are large enough, making the sum finite. To see how this works, we take a closer look at the definition of the TCC of Eq. (5).

The summation limits in Eq. (7) are now deduced from the bounds of the TCC integrals. Two geometrical conditions must be met simultaneously for nonzero values of the TCCs: 1) the separation between the centers of the two offset pupil functions must be less than twice their radius; and 2) both pupil functions must intersect the source function, which can be seen by reference again to FIG. 2. Letting k=m′−m″ and l=n′−n″, these conditions (1) and (2) translate into Eq. (9) and (10), respectively, as follows:

$$\begin{matrix}\vert {u}^{′} - {u}^{″} \vert \leq 2 ⇒ \frac{{k}^{2}}{{q}_{x}^{2}} + \frac{{l}^{2}}{{q}_{y}^{2}} \leq 4 , & ( 9 ) \\ max \{ \vert {u}^{′} \vert , \vert {u}^{″} \vert \} \leq 1 + σ ⇒ max \{ \frac{{m}^{′2}}{{q}_{x}^{2}} , \frac{{n}^{′2}}{{q}_{y}^{2}} , \frac{{m}^{″2}}{{q}_{x}^{2}} , \frac{{n}^{″2}}{{q}_{y}^{2}} \} \leq {( 1 + σ )}^{2} & ( 10 )\end{matrix}$$

which provide finite integration limits.

Note that, with this variable change, the intensity now takes the form of a Fourier series, which is expected from the periodic assumption. The conditions in Eqs. (9) and (10), and the change of variable suggested above, lead directly to the following exact finite sum for the intensity:

$$I ( x , y ) = {\sum }_{k = - {M}_{x}}^{{M}_{x}} {\sum }_{l = - {M}_{y} ( k )}^{{M}_{y} ( k )} {C}_{k l} exp [ - ⅈ2π ( k \frac{x}{P x} + l \frac{y}{P y} ) ] , \qquad ( 11 )$$

where

$$\begin{matrix}{M}_{x} = ⌊ 2 {q}_{x} ⌋ , & ( 12 ) \\ {M}_{y} ( k ) = ⌊ {q}_{y} \sqrt{4 - \frac{{k}^{2}}{{q}_{x}^{2}}} ⌋ , & ( 13 )\end{matrix}$$

where the function └x┘ is a floor function, representing the largest integer less than x (a real number), and

$$\begin{matrix}{C}_{k l} = {\sum }_{m = - k θ ( - k ) - {N}_{x}}^{{N}_{x} - k θ ( k )} {\sum }_{n = - l θ ( - l ) - {N}_{y} ( m , k )}^{{N}_{y} ( m , k ) - l θ ( l )} {c}_{m + k , n + l} {c}_{m n}^{*} {T}_{m + k , n + l , m , n} , & ( 14 ) \\ {N}_{x} = ⌊ ( 1 + σ ) {q}_{x} ⌋ , & ( 15 ) \\ {N}_{y} ( m , k ) = ⌊ {q}_{y} \sqrt{{( 1 + σ )}^{2} - \frac{{( m + k )}^{2}}{{q}_{x}^{2}}} ⌋ , & ( 16 )\end{matrix}$$

and θ is the Heaviside step function:

$$θ ( x ) = \{ \begin{matrix}1 , & x > 0 \\ 0 , & x < 0\end{matrix} . \qquad ( 17 )$$

The quantities c_{m+k,n+l} and c*ₘₙ are the discrete coefficients corresponding to the mask functions M,M* in the expression for intensity I(x) of Eq. (4). The number of TCCs needed can be deduced from Eqs. (11) and (14); however, it is difficult to get an intuitive feel for how this number behaves as a function of the optical parameters. Eqs. (9) and (10) describe integer lattices bounded by ellipses, and therefore the number of points bounded by the ellipses is roughly equal to the product of the ellipses areas. An approximation to the number of TCC's, T, in the limit of a large unit cell area, is

$$T \approx {π}^{2} ⌊ {( \frac{2 N A}{λ} )}^{2} {p}_{x} {p}_{y} ⌋ ⌊ {[ \frac{( 1 + σ ) N A}{λ} ]}^{2} {p}_{x} {p}_{y} ⌋ . \qquad ( 1$$

Note that this number is roughly proportional to the square of the period cell area.
3. Characterization of the Integration Region

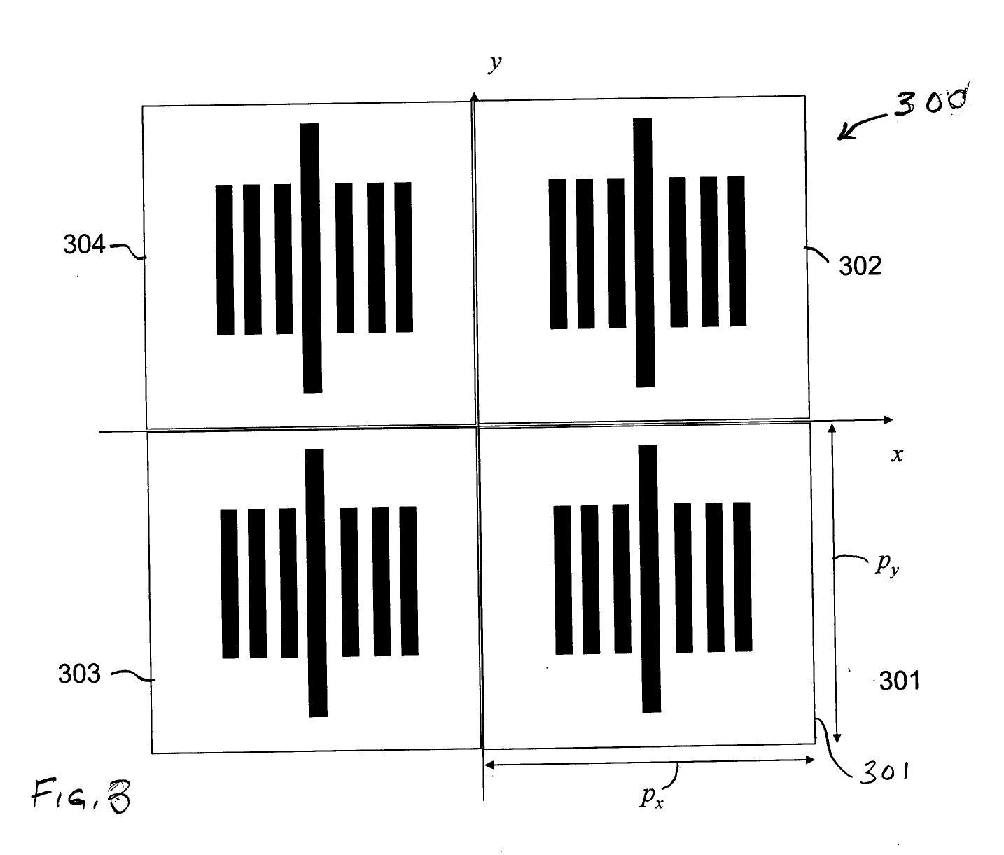

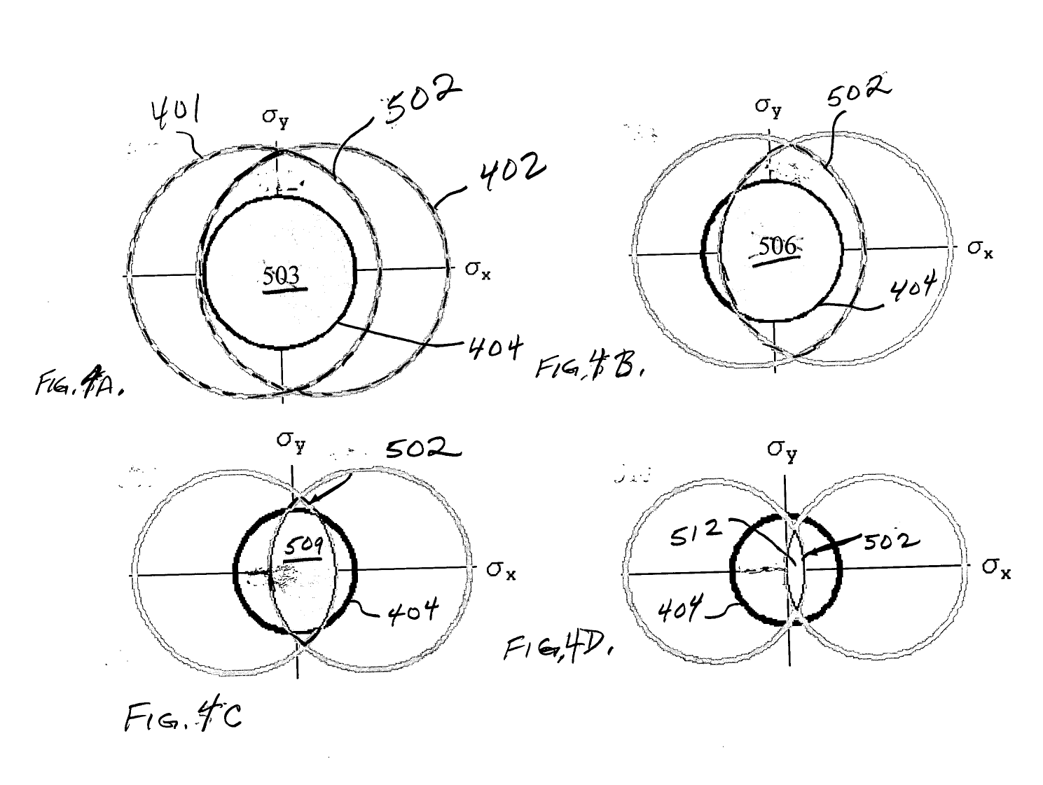

Referring again to FIG. 2, the computation of the in-focus TCC is reduced to simply computing the common area of three circles, two of which are offset from the origin and have unit radius (the pupils), while the other is centered at the origin and has radius of σ₀ (the source). Kintner (E. C. Kintner, “Method for the calculation of partially coherent imagery”, Applied Optics 17, pp. 2747-2753 (1978)) showed that, for the case of one-dimensional (1D) masks (i.e. diffraction gratings) where the centers of the pupils are constrained to lie on the horizontal (or vertical) axis, and where σ=1, the TCC integration region geometry can be categorized into one of only four distinct configurations of the intersection 502 of the offset pupils 401, 402 and of the source 404, as illustrated in FIGS. 4A-4D. These configurations are as follows:
1) the source 404 is completely contained within the pupil intersection 502 to form an integration region 503 as in FIG. 4A;
2) the source 404 protrudes out of one side of the pupil intersection 502 to form integration region 506 as in FIG. 4B;
3) the source 404 protrudes out of both sides of the pupil intersection 502 to form integration region 509 as in FIG. 4C; and
4) the pupil intersection 502 is completely contained within the source 404 to form an integration region 512 as in FIG. 4D.

Clearly, the situation for the general two-dimensional (2D) mask is drastically more complicated. The number of distinct geometrical configurations for a 2D mask has not been published prior to the present application; the typical approach to computing the 2D TCC has been to employ the minimum grid that contains the pupils and the source. Enumerating these integration regions is an important aid in determining the proper integration limits for analytical and adaptive 2D numerical integrations. It will be shown below, however, that, taking into account all possible symmetries, there are only 18 distinct geometrical configurations to consider.

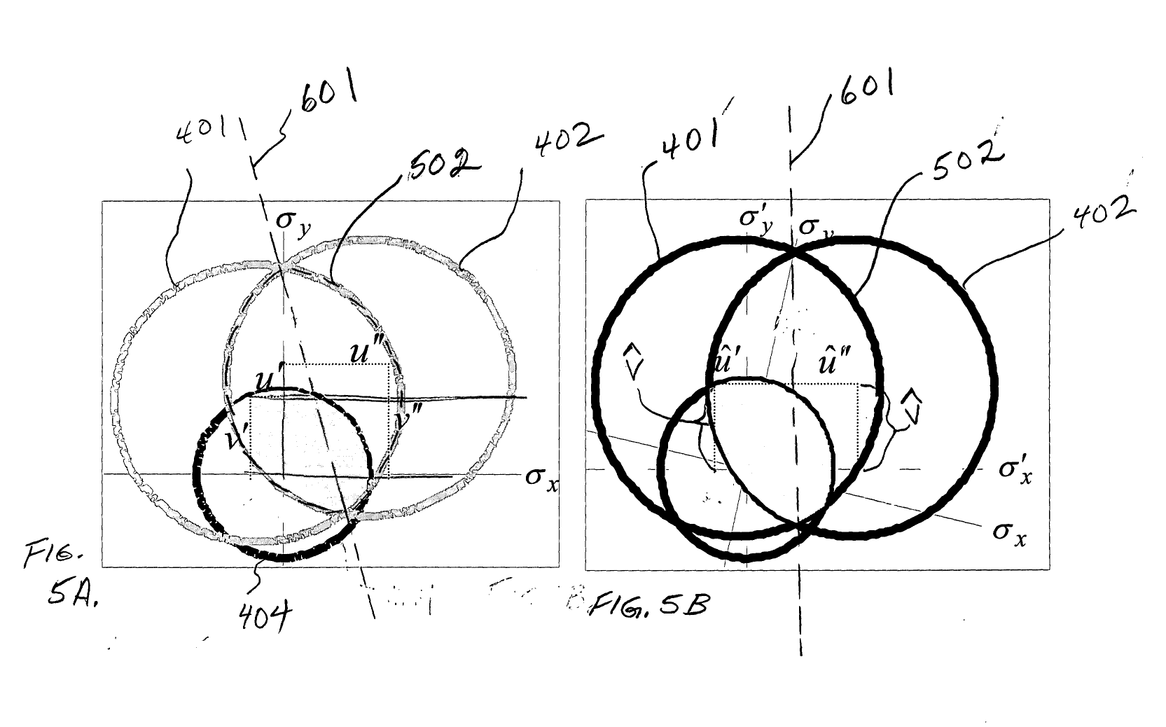

In considering the 2D case, note that the coordinate system can always be rotated such that the symmetry axis of the intersection region of the offset pupils is vertical (that is, aligned along one of the source coordinate axes). For example, FIG. 5A illustrates a source coordinate system having horizontal axis σₓ and vertical axis σ_{y} centered on a source 404. Also illustrated is an offset pupil function 401 having center coordinates (u′,v′) offset from the center of the source 404 and a second pupil 402 offset at (u″,v″) relative to the source 404. The pupils 401, 402 have an intersection region 502 whose axis of symmetry 601 is tilted with respect to the vertical axis σ_{y}. A coordinate rotation can be performed so that the new rotated vertical axis σ′_{y}, is parallel to the axis of symmetry 601 of the pupil intersection region 502, as illustrated in FIG. 5B. The pupils 401, 402 will have new center coordinates (û′,\hat{v}), (û″,\hat{v}), respectively. Note in particular that both pupil functions 401, 402 now have the same vertical center coordinate \hat{v} in the rotated coordinate system (σ′ₓ,σ′_{y}). By performing this rotation, the myriad of possible geometrical combinations is limited, and only a single vertical coordinate is necessary to specify the TCC. Organizing the different cases is also simplified, as the 2D TCC can now be viewed as a perturbation of the 1D TCC. The various geometries can then be organized by their configuration with the y-components of the frequencies set to zero.

Before enumerating the different cases, the desired change of coordinates is stated. Let the tangent of the rotation angle be denoted as

$$r = \frac{{v}^{′} - {v}^{″}}{{u}^{′} - {u}^{″}} . \qquad ( 18 )$$

Then the horizontal offsets and the common vertical offset are as follows:

$$\begin{matrix}{\hat{u}}^{′} = \frac{{u}^{′} + r {v}^{′}}{\sqrt{1 + {r}^{2}}} , {\hat{u}}^{″} = \frac{{u}^{″} + r {v}^{″}}{\sqrt{1 + {r}^{2}}} , & ( 19 a ) \\ \hat{v} = \frac{- r {u}^{′} + {v}^{′}}{\sqrt{1 + {r}^{2}}} . & ( 19 b )\end{matrix}$$

Also, denote u₁=max{û′,û″}, u₂=min{û′,û″}, and v=\hat{v}.

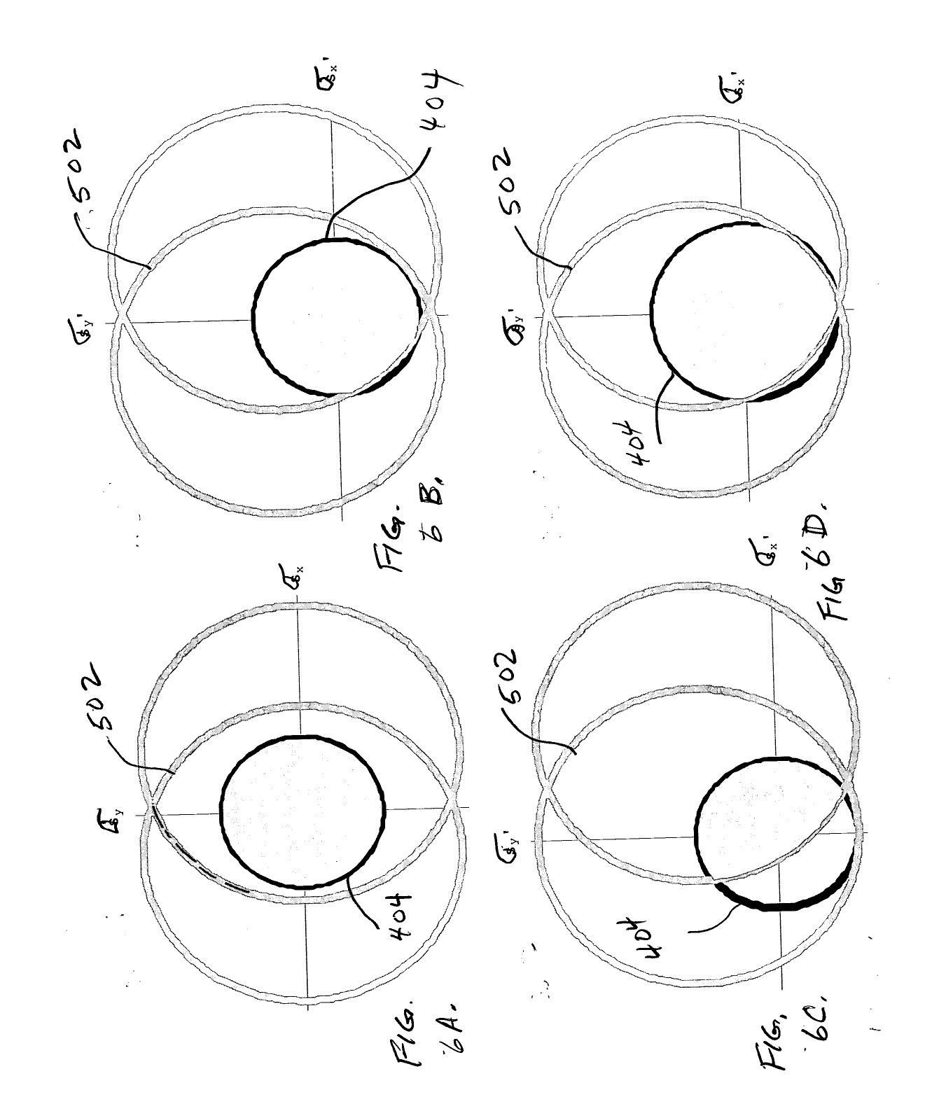

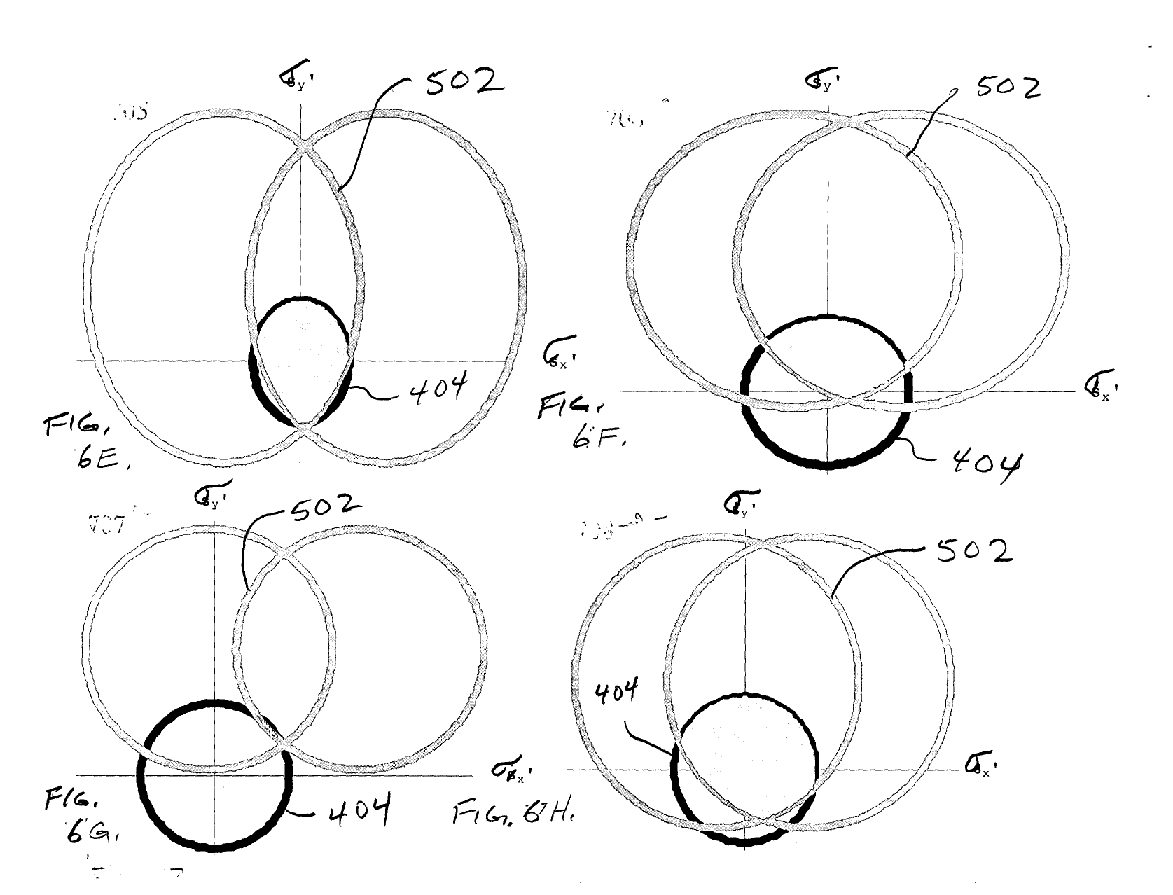

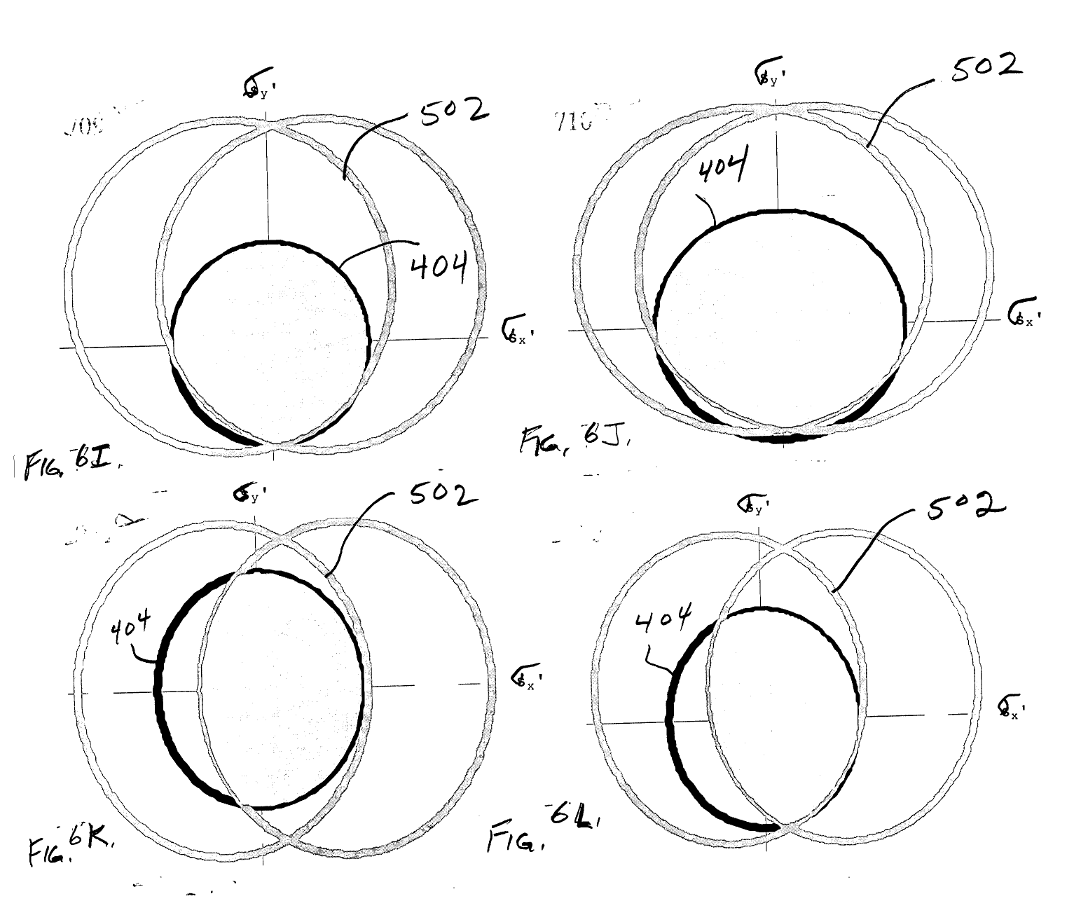

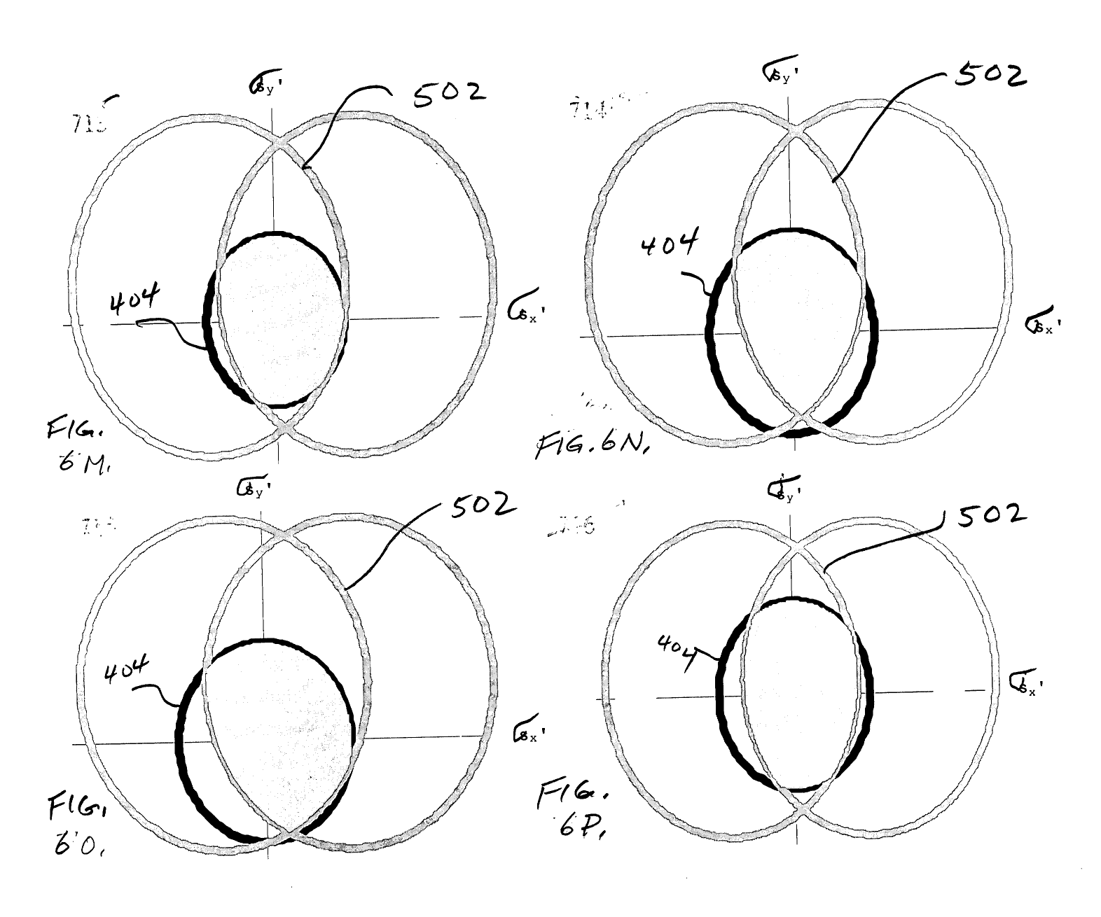

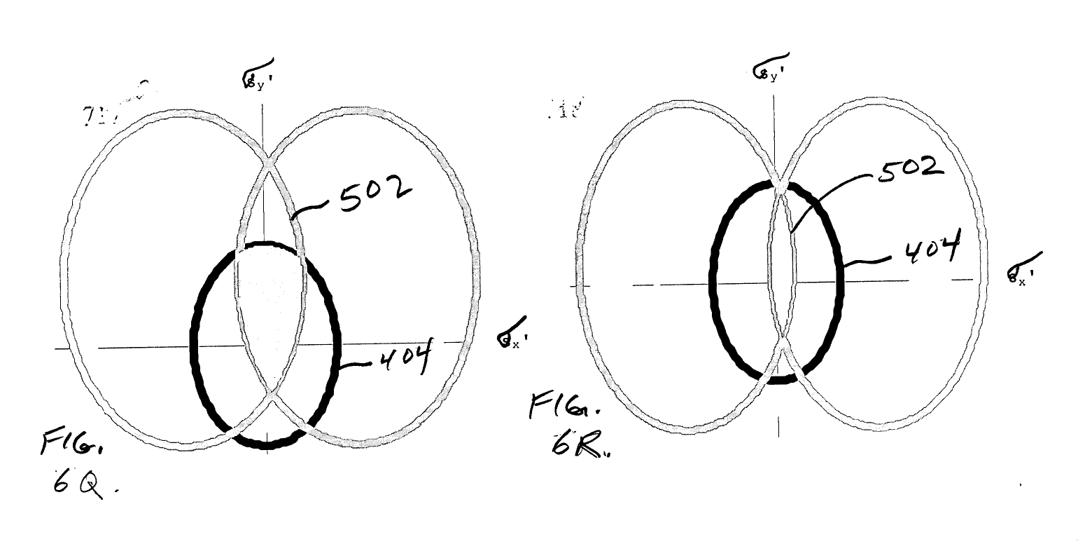

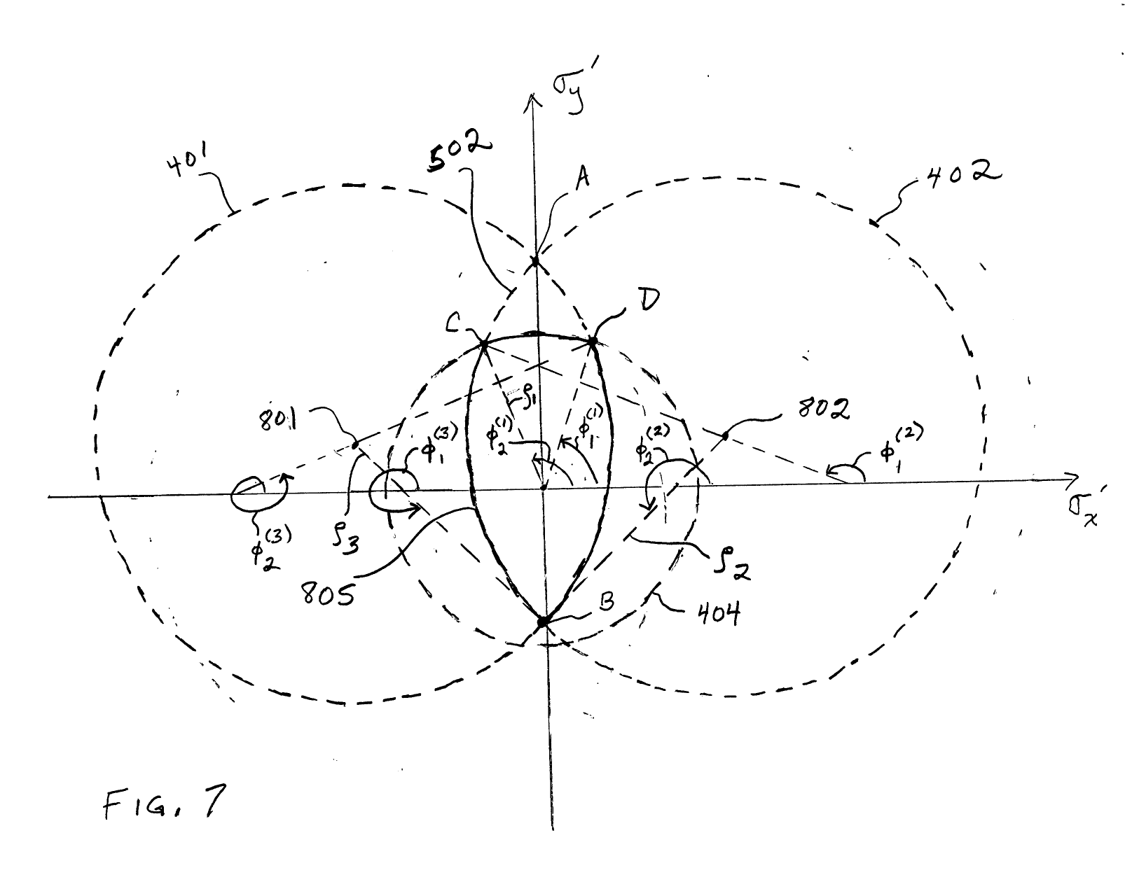

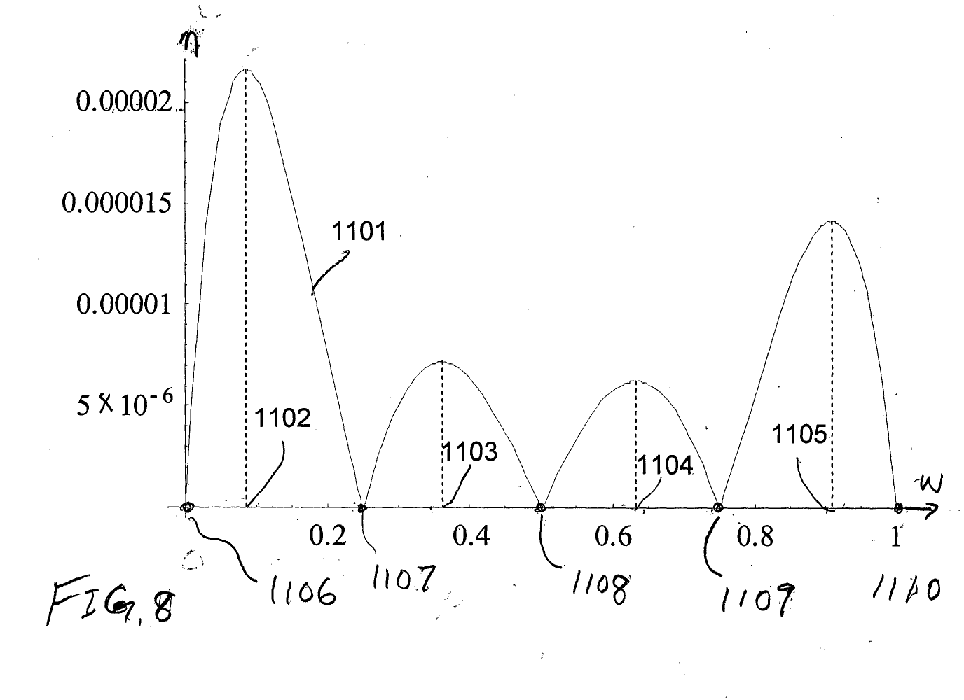

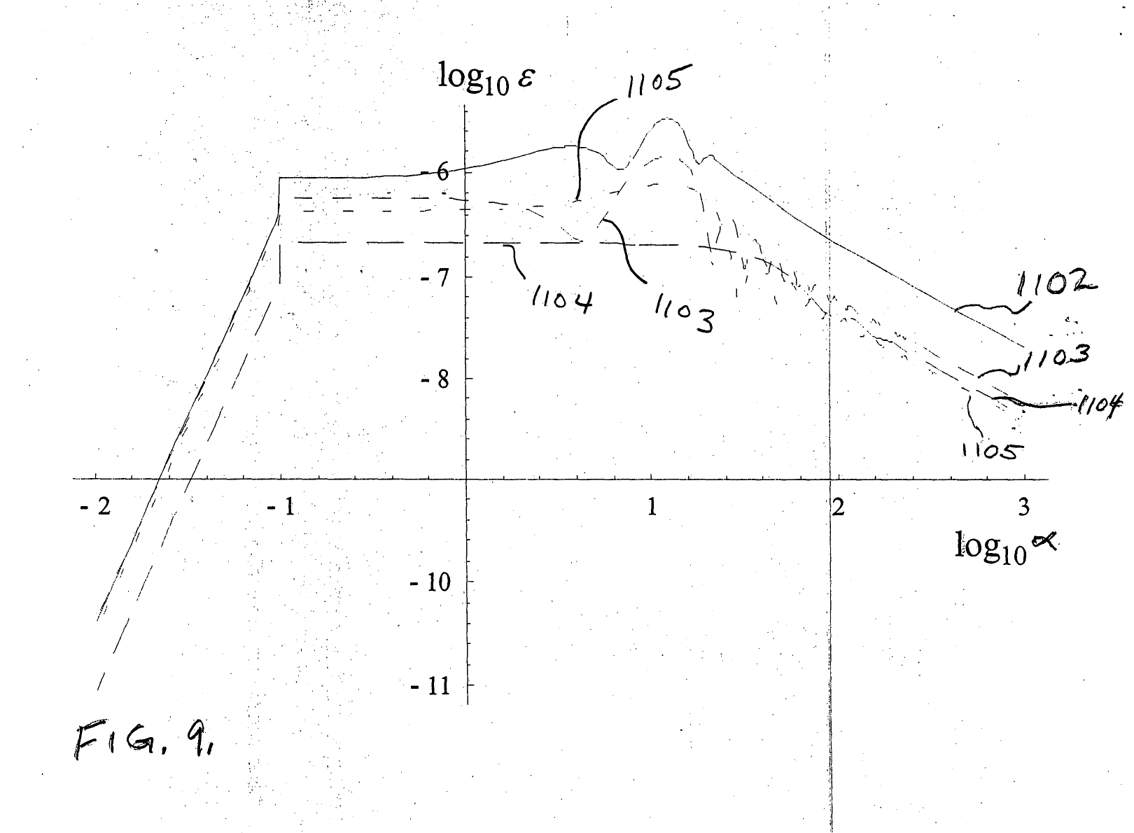

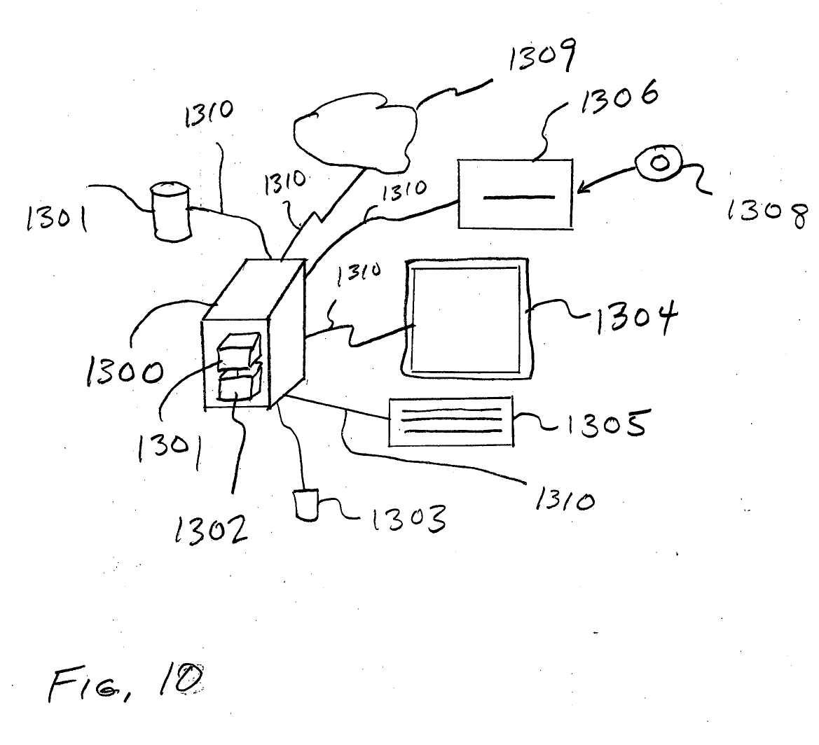

In the following descriptions of the integration regions of interest for the two-dimensional case, the organization is as follows. The two-dimensional geometric configurations may be categorized by analogy to the four one-dimensional cases. In each of these four categories of geometries, the pupils are moved together vertically, and each change in geometry is noted. Note that one geometric configuration can be derived from more than one logical condition. The cases are illustrated in FIGS. 6A-6R, in the coordinate axes have been rotated around the center of the source function 404 to align with the axis of symmetry of the pupil intersection region 502.

3.1) The Source is Completely Contained within the Pupil Intersection

This is achieved when u₁−1<−σ₀ and u₂+1>σ₀.

In this first category, the changes in geometry as the pupil intersection region 502 is moved vertically relative to the source function 404 are considered. It is assumed that |u₁|≧|u₂|; the complementary case results in the mirror image about the vertical. The following quantities are defined:

$$\begin{matrix}{v}_{1} = \sqrt{{( 1 - {σ}_{0} )}^{2} - {u}_{1}^{2}} , & ( 20 ) \\ {v}_{2} = \sqrt{1 - {( {σ}_{0} + {u}_{1} )}^{2}} , & ( 21 ) \\ {v}_{3} = \sqrt{{( 1 - {σ}_{0} )}^{2} - {u}_{2}^{2}} , & ( 22 ) \\ {v}_{4} = \sqrt{1 - {( {σ}_{0} + {u}_{2} )}^{2}} , & ( 23 ) \\ {v}_{α} = \sqrt{1 - \frac{1}{4} {( {u}_{1} - {u}_{2} )}^{2}} , & ( 24 ) \\ {v}_{β} = \sqrt{{σ}_{0}^{2} - \frac{1}{4} {( {u}_{1} + {u}_{2} )}^{2}} , & ( 25 ) \\ {v}_{5} = {v}_{α} - {v}_{β} , & ( 26 ) \\ {v}_{6} = {v}_{α} + {v}_{β} , & ( 27 ) \\ {v}_{7} = \sqrt{{( 1 + {σ}_{0} )}^{2} - {u}_{1}^{2}} , & ( 28 ) \\ {v}_{8} = \sqrt{{( 1 + {σ}_{0} )}^{2} - {u}_{2}^{2}} , & ( 29 ) \\ {v}_{9} = \sqrt{{σ}_{0}^{2} - {( 1 - {u}_{1} )}^{2}} , & ( 30 ) \\ {v}_{10} = \sqrt{{σ}_{0}^{2} - {( 1 - {u}_{2} )}^{2}} , & ( 31 ) \\ {v}_{11} = \sqrt{{σ}_{0}^{2} - {( 1 + {u}_{1} )}^{2}} , & ( 32 ) \\ {v}_{12} = \sqrt{{σ}_{0}^{2} - {( 1 + {u}_{2} )}^{2}} , & ( 33 ) \\ {v}_{13} = \sqrt{1 - {( {σ}_{0} - \vert {u}_{1} \vert )}^{2}} , & ( 34 ) \\ {v}_{14} = \sqrt{1 - {( {σ}_{0} - \vert {u}_{2} \vert )}^{2}} . & ( 35 )\end{matrix}$$

Then the distinct geometrical cases are determined under the following conditions:
Case 1 (FIG. 6A): |v|<v₁.
Case 2 (FIG. 6B): u₂<0, v₂<v₃ and v₁<|v|<v₂.
u₂<0, v₃<v₂ and v₁<|v|<v₃.
u₂>0, v₂<v₅ and v₁<|v|<v₂.
u₂>0, v₂>v₅ and v₁<|v|<v₅.
Case 3 (FIG. 6C): u₂<0, v₂<v₃ and v₂<|v|<v₃.
u₂>0, v₂<v₅ and v₂<|v|<v₅.
Case 4 (FIG. 6D): u₂<0, v₂<v₃, v₄<v₅, and v₃<|v|<v₄.
u₂<0, v₂<v₃, v₄>v₅, and v₃<|v|<v₅.
u₂<0, v₂>v₃, v₄<v₅, and v₂<|v|<v₄.
u₂<0, v₂>v₃, v₄>v₅, and v₂<|v|<v₅.
Case 5 (FIG. 6E): u₂<0, v₄<v₅, and v₄<|v|<v₅.
Case 6 (FIG. 6F): u₂<0, v₄<v₅, and v₅<|v|<v₆.
v₄>v₅, and v₄<|v|<v₆.

$$Case 7 ( FIG . 6 G ) \text{:}$$

$${u}_{2} < - \frac{1 - {σ}_{0}}{1 + {σ}_{0}} {u}_{1} , and {v}_{6} < \vert v \vert < {v}_{7} .$$

Case 8 (FIG. 6H): u₂<0, v₄>v₅, and v₅<|v|<v₄.
Case 9 (FIG. 6I): u₂>0, v₂>v₅ and v₅<|v|<v₂.
Case 10 (FIG. 6J): u₂<0, v₂>v₃, and v₃<|v|<v₂.

3.2) The Source Protrudes Out of One Side of the Pupil Intersection

Recall that only the case of |u₁|≧|u₂| is being considered; the other case follows by symmetry. This is achieved when u₁−1>−σ₀ and u₂+1>σ₀, and the distinct geometrical cases are determined under the following conditions:

$$Case 11 ( FIG . 6 K ) \text{:}$$

$${u}_{2} < - \frac{1 - {σ}_{0}}{1 + {σ}_{0}} {u}_{1} , {v}_{9} < {v}_{3} , \vert v \vert < {v}_{9} . \\ {u}_{2} < - \frac{1 - {σ}_{0}}{1 + {σ}_{0}} {u}_{1} , {v}_{9} > {v}_{3} , \vert v \vert < {v}_{3} . \\ - \frac{1 - {σ}_{0}}{1 + {σ}_{0}} {u}_{1} < {u}_{2} < 2 {σ}_{0} - {u}_{1} , \vert v \vert < {v}_{9} . \\ {u}_{2} > 2 {σ}_{0} - {u}_{1} , \vert v \vert < {v}_{9} . \\ Case 12 ( FIG . 6 L ) \text{:}$$

$${u}_{2} < - \frac{1 - {σ}_{0}}{1 + {σ}_{0}} {u}_{1} , {v}_{9} > {v}_{3} , {v}_{9} < {v}_{10} , {v}_{5} < {v}_{9} , {v}_{3} < \vert v \vert < {v}_{5} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{3} < \vert v \vert < {v}_{9} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{3} < \vert v \vert < {v}_{10} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} < {v}_{10} , {v}_{3} < \vert v \vert < {v}_{5} . \\ Case 13 ( FIG . 6 M ) \text{:}$$

$${u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} > {v}_{9} , {v}_{3} < \vert v \vert < {v}_{9} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} < {v}_{9} , {v}_{3} < \vert v \vert < {v}_{5} . \\ Case 14 ( FIG . 6 N ) \text{:}$$

$${u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} < {v}_{9} , {v}_{5} < \vert v \vert < {v}_{9} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} < {v}_{9} , {v}_{5} < \vert v \vert < {v}_{9} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} > {v}_{10} , {v}_{10} < \vert v \vert < {v}_{9} . \\ Case 15 ( FIG . 6 O ) \text{:}$$

$${u}_{2} < - \frac{1 - {σ}_{0}}{1 + {σ}_{0}} {u}_{1} , {v}_{9} > {v}_{3} , {v}_{9} < {v}_{10} , {v}_{5} < {v}_{9} , {v}_{5} < \vert v \vert < {v}_{9} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} < {v}_{10} , {v}_{5} < \vert v \vert < {v}_{10} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} < {v}_{10} , {v}_{5} < \vert v \vert < {v}_{9} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} > {v}_{10} , {v}_{5} < \vert v \vert < {v}_{10} .$$

There are also many cases that revert back to a region defined in subsection 1:

$$Case 3 \text{:}$$

$${u}_{2} < - \frac{1 - {σ}_{0}}{1 + {σ}_{0}} {u}_{1} , {v}_{9} < {v}_{3} , {v}_{9} < \vert v \vert < {v}_{3} . \\ - \frac{1 - {σ}_{0}}{1 + {σ}_{0}} {u}_{1} < {u}_{2} < 2 {σ}_{0} - {u}_{1} , {v}_{9} < {v}_{5} , {v}_{9} < \vert v \vert < {v}_{5} . \\ {u}_{2} > 2 {σ}_{0} - {u}_{1} , {v}_{9} < \vert v \vert < {v}_{13} . \\ Case 4 \text{:}$$

$${u}_{2} < - \frac{1 - {σ}_{0}}{1 + {σ}_{0}} {u}_{1} , {v}_{9} < {v}_{3} , {v}_{10} < {v}_{5} , {v}_{3} < \vert v \vert < {v}_{10} . \\ {u}_{2} < - \frac{1 - {σ}_{0}}{1 + {σ}_{0}} {u}_{1} , {v}_{9} < {v}_{3} , {v}_{10} > {v}_{5} , {v}_{3} < \vert v \vert < {v}_{5} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{10} < {v}_{5} , {v}_{9} < \vert v \vert < {v}_{10} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{10} > {v}_{5} , {v}_{9} < \vert v \vert < {v}_{5} . \\ Case 5 \text{:}$$

$${u}_{2} < - \frac{1 - {σ}_{0}}{1 + {σ}_{0}} {u}_{1} , {v}_{9} < {v}_{3} , {v}_{10} < {v}_{5} , {v}_{10} < \vert v \vert < {v}_{5} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{10} < {v}_{5} , {v}_{10} < \vert v \vert < {v}_{5} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} > {v}_{9} , {v}_{9} < \vert v \vert < {v}_{5} . \\ Case 6 \text{:}$$

$${u}_{2} < - \frac{1 - {σ}_{0}}{1 + {σ}_{0}} {u}_{1} , {v}_{9} < {v}_{3} , {v}_{10} < {v}_{5} , {v}_{5} < \vert v \vert < {v}_{6} . \\ {u}_{2} < - \frac{1 - {σ}_{0}}{1 + {σ}_{0}} {u}_{1} , {v}_{9} < {v}_{3} , {v}_{5} < {v}_{10} , {v}_{10} < \vert v \vert < {v}_{6} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} < {v}_{9} , {v}_{10} < \vert v \vert < {v}_{6} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{10} < {v}_{5} , {v}_{5} < \vert v \vert < {v}_{6} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{10} > {v}_{5} , {v}_{10} < \vert v \vert < {v}_{6} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} > {v}_{9} , {v}_{5} < \vert v \vert < {v}_{6} . \\ {u}_{2} < - \frac{1 - {σ}_{0}}{1 + {σ}_{0}} {u}_{1} , {v}_{9} > {v}_{3} , {v}_{10} < {v}_{9} , {v}_{5} > {v}_{10} , {v}_{5} < {v}_{9} , {v}_{9} < \vert v \vert < {v}_{6} . \\ - \frac{1 - {σ}_{0}}{1 + {σ}_{0}} {u}_{1} < {u}_{2} < 2 {σ}_{0} - {u}_{1} , {v}_{9} < {v}_{5} , {v}_{10} < \vert v \vert < {v}_{6} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} < {v}_{10} , {v}_{10} < \vert v \vert < {v}_{6} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} > {v}_{10} , {v}_{9} < \vert v \vert < {v}_{6} . \\ Case 7 \text{:}$$

$${u}_{2} < - \frac{1 - {σ}_{0}}{1 + {σ}_{0}} {u}_{1} , {v}_{9} > {v}_{3} , {v}_{9} < {v}_{10} , {v}_{5} < {v}_{9} , {v}_{9} < \vert v \vert < {v}_{10} . \\ {u}_{2} < - \frac{1 - {σ}_{0}}{1 + {σ}_{0}} {u}_{1} , {v}_{9} > {v}_{3} , {v}_{9} < {v}_{10} , {v}_{5} > {v}_{9} , {v}_{10} > {v}_{5} , {v}_{5} < \vert v \vert < {v}_{10} . \\ - \frac{1 - {σ}_{0}}{1 + {σ}_{0}} {u}_{1} < {u}_{2} < 2 {σ}_{0} - {u}_{1} , {v}_{9} < {v}_{5} , {v}_{6} < \vert v \vert < {v}_{7} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} < {v}_{10} , {v}_{9} < \vert v \vert < {v}_{10} . \\ - \frac{1 - {σ}_{0}}{1 + {σ}_{0}} {u}_{1} < {u}_{2} < 2 {σ}_{0} - {u}_{1} , {v}_{5} < {v}_{9} , {v}_{9} < {v}_{10} , {v}_{6} < \vert v \vert < {v}_{7} . \\ {u}_{2} < 2 {σ}_{0} - {u}_{1} , {v}_{13} < \vert v \vert < {v}_{7} . \\ Case 8 \text{:}$$

$${u}_{2} < - \frac{1 - {σ}_{0}}{1 + {σ}_{0}} {u}_{1} , {v}_{9} < {v}_{3} , {v}_{10} < {v}_{5} , {v}_{10} < \vert v \vert < {v}_{5} . \\ - \frac{1 - {σ}_{0}}{1 + {σ}_{0}} {u}_{1} < {u}_{2} < 2 {σ}_{0} - {u}_{1} , {v}_{9} < {v}_{5} , {v}_{5} < \vert v \vert < {v}_{10} .$$

3.3) The Source Protrudes Out of Both Sides of the Pupil Intersection

This is achieved when u₁+1>−σ₀, and u₂+1<σ₀, and σ₀²<u₁u₂+1, and the distinct geometrical cases are determined under the following conditions:
Case 16 (FIG. 6P): v₅<v₁₄,|v|<v₅.
v₅>v₁₄, |v|<v₁₄.
Case 17 (FIG. 6Q): v₅<v₁₄, v₅<|v|<v₁₄.
Cases that revert back to regions defined in subsections 1 and 2:
Case 5: v₅>v₁₄, v₅>v₁₃, v₁₃<|v|<v₅.
Case 6: v₅<v₁₄, v₁₃<|v|<v₆.
v₅>v₁₄, v₅<v₁₃, v₁₃<|v|<v₆.
v₅>v₁₄, v₅>v₁₃, v₅<|v|<v₆.
Case 13: v₅>v₁₄, v₅<v₁₃, v₁₄<|v|<v₅.
v₅>v₁₄, v₅>v₁₃, v₁₄<|v|<v₁₃.
Case 14: v₅<v₁₄, v₁₄<|v|<v₁₃.
v₅>v₁₄, v₅<v₁₃, v₅<|v|<v₁₃.

3.4) The Pupil Intersection is Completely Contained within the Source

This is achieved when u₁−1>−σ₀, u₂+1<σ₀, and σ₀²<u₁u₂+1, and the distinct geometrical cases are determnined under the following conditions:
Case 18 (FIG. 6R): |v|<v₅.
Cases that revert back to regions defined in previous subsections:
Case 6: v₁₃<|v|<v₆.
Case 14: v₁₄<|v|<v₁₃.
Case 17: v₅<|v|<v₁₄.
4. Simplification via Contour Integration

The main result of the previous subsection was to identify all of the possible geometrical forms for the regions of integration for the TCCs, and the conditions under which each particular form would occur.

Consider the case of in-focus imaging, where the image plane is coincident with the focal plane of the projection lens. The pupil function P(u) takes the value 1 when |u|≦1 and zero when |u|>1. Then the in-focus TCCs are simply the areas of their respective regions. Given that each of the bounding contours of these regions is a circular arc, the determination of the areas exactly in terms of analytic functions is straightforward. There would be 18 separate analytical expressions to be evaluated according to the integration regions defined above, which is unwieldy to implement. However, it is possible to simply the 18 analytical expressions into a common form, as disclosed in Gordon (see Gordon, R. L., “Exact Computation of Scalar, 2D Aerial Imagery,” Proc. SPIE, Vol. 4692, pp. 517-528 (2002)).

This is accomplished by using Green's Theorem to convert the area integrals to contour integrals. According to Green's Theorem, the expression of the area A (e.g., the TCC for the in-focus case) of a closed region D can be expressed in terms of its bounding contour:

$$A ( D ) = {\int }_{D} {ⅆ}^{2} σ = \frac{1}{2} {∮}_{\partial D} ( {σ}_{x} ⅆ {σ}_{y} - {σ}_{y} ⅆ {σ}_{x} ) . \qquad ( 36 )$$

Because the closed contour consists of nothing more than a set of circular arcs, the parametrization of the above contour integral is achieved using the following parametrization: σₓ=u₀^{(k)}+ρₖ cos φ, σ_{y}=v₀^{(k)}+ρₖ sin φ; the final result takes the form

$$A ( D ) = \frac{1}{2} {\sum }_{k = 1}^{N} \{ {ρ}_{k}^{2} ( {ϕ}_{2}^{( k )} - {ϕ}_{1}^{( k )} ) + {ρ}_{k} [ {u}_{0}^{( k )} ( {s}_{2}^{( k )} - {s}_{1}^{( k )} ) - {v}_{0}^{( k )} ( {c}_{2}^{( k )} - {c}_{1}^{( k )} ) ] \} , \qquad ( 37 )$$

where the following notation applies:
ρₖ is the radius, and (u₀^{(k)},v₀^{(k)}) is the center of the circle containing the kth arc.
φ₂^{(k)} and φ₁^{(k)} are the angles subtended by the endpoints of the kth arc at its circle's center measured clockwise with respect to the positive horizontal axis σₓ. For example, FIG. 7 illustrates a source function 404 and two offset pupil functions 401, 404 having center coordinates 801, 802 respectively. The intersection of the two pupil functions 502 is the region enclosed by the two circular arcs having endpoints A, B. The integration region 805 is defined by the intersection of the source function 404 and the two pupil functions 401, 402, and is the region enclosed by the arcs having endpoints C, D and B. In this example, there are three circular arcs: 1) the arc having endpoints C, D having radius ρ₁ of the source function; 2) the arc having endpoints C, B having radius ρ₂ corresponding to the pupil function 402 centered at coordinate 802; and 3) the arc defined by endpoints B, D having radius ρ₃ corresponding to the first pupil function 401 centered at 801. The angles corresponding to the endpoints of arc C-D are φ₂⁽¹⁾,φ₁⁽¹⁾, respectively; for arc C-B the angles are φ₁⁽²⁾,φ₂⁽²⁾, respectively; and for arc C-D the angles are φ₁⁽³⁾,φ₂⁽³⁾, respectively, where all of the angles are measured clockwise with respect to the positive horizontal axis. In addition, sⱼ^{(k)}=sin φⱼ^{(k)}, cⱼ^{(k)}=cos φⱼ^{(k)}, jε{1,2}, and N is the number of arcs in the contour.

There are two immediate advantages to the contour integration method:
1) The number of unique geometrical configurations of the integration regions shrinks from 18 to 9, which would simplify the used used to compute TCCs. This number is less because some of the integration regions detailed above have the same type of boundary.
2) The final expression for the in-focus TCC takes the form of Eq. (37) which is evaluated with a single arctangent and a few square roots per arc, resulting in a more efficient algorithm.
   5. Extension to Defocus

For scalar, moderate-to-high NA systems (i.e., NA between about 0.5 to 0.7), the pupil function of a defocused system (i.e. at a defocus position z along the optical axis) generally takes the form

$${P}_{D} ( u ) = exp [ - ⅈ2π \frac{z}{λ} ( 1 - \sqrt{1 - N {A}^{2} {u}^{2}} ) ] . \qquad ( 38 )$$

Generally speaking, one must attack the problem of computing the TCCs with the pupil function in Eq. (38) numerically. However, as previously discussed, numerical computations of TCCs are slow and have errors that are not well understood. In accordance with this invention, the TCCs for defocused systems (i.e. to compute defocused images) are expressed in terms of standard, analytical functions, as described in more detail below. This is to be done without sacrificing accuracy, as other algorithms, such as SOCS or bilinear decomposition, must do.

A standard approximation for the defocused pupil function of Eq. (38) is the quadratic-phase, or paraxial, approximation, which is useful for small values of NA (e.g. less than about 0.5), which leads to the following expression for the defocused, paraxial pupil function:

$${P}_{DP} ( u ) = exp ( - ⅈπ \frac{z}{λ} N {A}^{2} {u}^{2} ) . \qquad ( 39 )$$

Substituting P_{DP} of Eq. (39) into the TCC integral of Eq. (5) leads to the following expression for the TCC:

$$T ( {u}^{′} , {u}^{″} ) = C {\int }_{D ⋂ S} {ⅆ}^{2} σexp ( - ⅈ2π a \cdot σ ) , \qquad ( 40 )$$

where D is the intersection of the pupils, S is the source, a=−NA²z(u′−u″)/λ, and C is a phase term, where

$$C = exp ( - ⅈπ N {A}^{2} \frac{z}{λ} ( {u}^{′2} - {u}^{″2} ) ) .$$

The TCC integral in Eq. (40) now has the problem of having a nonuniform integrand over the intersection region D∩S. By analogy to the in-focus case discussed above, Stokes' Theorem can be applied to convert the TCC area integral of Eq. 40 into a contour integral. This is shown as follows. Consider the vector-valued function:
∇\hat{ }F=exp(−i2πa·σ)\hat{z} (41)
where \hat{z} is a unit vector in the direction of the normal to the σ plane. Stokes Theorem converts the TCC double integral in Eq. (40) to a single, contour integral around the boundary of the integration region:

$${\int }_{D ⋂ S} {ⅆ}^{2} σ \cdot ∇ ⋀ F = {∮}_{\partial ( D ⋂ S )} ⅆ σ \cdot F . \qquad ( 42 )$$

The idea is to find the value of F, given ∇\hat{ }F. F can be found exactly because it is a solution of the vector wave equation. That is, F can be written as

$$F = - \frac{1}{ⅈ2π} \frac{{a}_{y} \hat{x} - {a}_{x} \hat{y}}{{a}_{x}^{2} + {a}_{y}^{2}} exp ( - ⅈ2π a \cdot σ ) , \qquad ( 43 )$$

where \hat{x} is a vector in the σₓ direction and ŷ is a vector in the σ_{y}.

The expression in Eq. (43) is then put into the right-hand side of Eq. (42). The reduction of this contour integral into a simple, single integral will depend on the boundary arc. The boundary of the integration region is made up of anywhere between 1 and 4 circular arcs with distinct centers and radii. Actually, there are only two distinct types of arcs:
1) the boundary of the source function in σ-space is described by σₓ²+σ_{y}²=σ₀²; and
2) the boundary of the pupil function in σ-space is described by (σₓ−uₓ)²+(σ_{y}−u_{y})²=1

If these arcs are parameterized by the angle subtended from the center of their respective circles, then it turns out that both types of boundaries lead to the following single integral expression for the TCC, in accordance with the present invention:

$$T ( {u}^{′} , {u}^{″} ) = - \frac{exp ( - ⅈπ b )}{ⅈ2π \vert a \vert} {\sum }_{j = 1}^{N} {ρ}_{j} [ J ( 2 {πρ}_{j} \vert a \vert , {ϕ}_{0} + {ϕ}_{2}^{( j )} ) - J ( 2 {πρ}_{j} \vert a \vert , {ϕ}_{0} + {ϕ}_{1}^{( j )} ) ] , \qquad ( 44 )$$

where

$$\begin{matrix}{ρ}_{j} = \{ \begin{matrix}{σ}_{0} , & source \\ 1 , & pupil\end{matrix} & ( 45 ) \\ {ϕ}_{0} = {Tan}^{- 1} \frac{{a}_{y}}{{a}_{x}} , & ( 46 )\end{matrix}$$

φ₁^{(j)},φ₂^{(j)} are the angles corresponding to the endpoints of the arc, as illustrated in FIG. 7, and N is the number of circular arcs on the contour, and:

$$J ( α , β ) = {\int }_{0}^{β} ⅆ {β}^{′} cos {β}^{′} exp ( - ⅈ α cos {β}^{′} ) . \qquad ( 47 )$$

Thus, the TCC in Eq. (44) is now expressed in terms of single integrals, rather than the double integrals of prior art TCC expressions. This integral is therefore more easily computed by numerical methods. However, it would be more desirable to compute these single integrals analytically to improve speed and accuracy. Unfortunately, the integral in Eq. (47) cannot be reduced to an exact analytical form, except for a few isolated special cases. More preferably, the integrand of Eq. (47) is replaced by a different function that differs from the original integrand by at most, some small number ε. This new integrand function will be chosen such that the integral can be expressed in terms of purely analytical functions.

First, note that Eq. (47) can be exactly rewritten in the following form:

$$J ( α , β ) = sin β exp ( ⅈ α cos β ) + ⅈ α {\int }_{1}^{cos β} ⅆ w \sqrt{1 - {w}^{2}} exp ( - ⅈ α w ) . \qquad ( 48 )$$

Again, the integral on the right in Eq. (48) is not expressible in terms of analytical functions. Note in particular that \sqrt{1−w²}=\sqrt{1−w}·\sqrt{1+w}. The first term \sqrt{1+w} has the property that it has a vertical tangent at w=1, but the integral of \sqrt{1−w} has a known analytical solution. The second term \sqrt{1+w} is smoothly varying, but the integral does not have a known analytical solution. Therefore, in accordance with the present invention, an approximation for the integrand \sqrt{1−w²} is made that preserves the properties of the first term \sqrt{1−w} (i.e. has a vertical tangent at w=1) and has smoothly varying properties, that is, the error decreases substantially monotonically as the number of terms in the approximation increases. In a preferred embodiment, the following polynomial approximation can be made for the integrand \sqrt{1−w²} over the interval for w of [0,1] (which covers all possible values of cos β):

$$\sqrt{1 - {w}^{2}} = \sqrt{1 - w} ( 1 + {\sum }_{m = 1}^{L} {f}_{m} {w}^{m} ) + η . \qquad ( 49 )$$

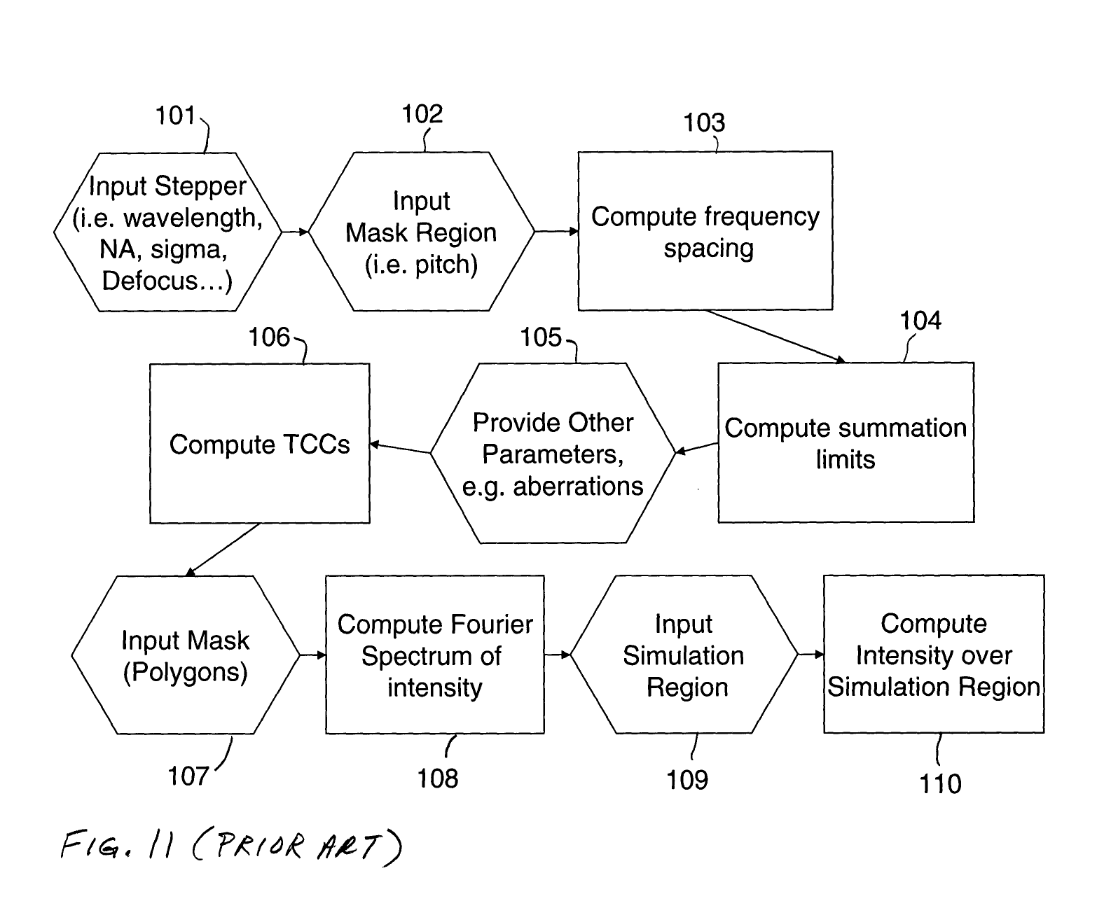

For a given finite value of L, the coefficients fₘ may be determined by performing a curve fit of the polynomial to \sqrt{1−w²} at L+1 discrete values of w. In a preferred embodiment, for a given number of terms L, the coefficients fₘ are found by equating values of the left and right sides of Eq. (49) at equal steps over the interval for w of [0,1] and are deduced by solving a linear system of equations. It turns out that when L=4, the error |η|<10⁻⁵, which is sufficient for a typical single precision calculation. For example, referring to FIG. 8, a plot of the absolute value of η 1101, i.e. the difference between the function \sqrt{1−w²} on the left hand side of Eq. (49) and the right hand side of Eq. (49) for L=4 (i.e. the curve fit at points 1106, 1107, 1108, 1109 and 1110). Note that the maximum error is about 2×10⁻⁵ at the point w=0.08 (1102).

Substituting the polynomial expression of Eq. (49) into the integral of Eq. (48) leads to a series of integrals. To evaluate the integral of the first term of the polynomial approximation from Eq. (49) we can make use of the following integral expression:

$$\int ⅆ w \sqrt{1 - w} exp ( - ⅈ α w ) = - ⅈexp ( - ⅈ α ) {α}^{- 3 / 2} \sqrt{\frac{π}{2}} F [ \sqrt{\frac{2}{π}} α ( 1 - w ) ] + ⅈ exp ( - ⅈ α w ) {α}^{- 1} \sqrt{1 - w} , \qquad ( 50 )$$

where

$$F ( ζ ) = {\int }_{0}^{ζ} ⅆ t exp ( ⅈ \frac{π}{2} {t}^{2} ) \qquad ( 51 )$$

is the Fresnel integral. Although the Fresnel integral is not typically recognized as a standard analytical function, it does, in fact, contain all of the properties of such functions, and, most importantly here, can be computed to within machine precision using a (countably) small number of arithmetic operations, for example, by using a continued fraction expansion that is highly convergent, as is well known in the art.

The integrals from Eq. (48) including the higher order terms in the polynomial from Eq. (49) are computed using the relation

$$\int ⅆ {ww}^{m} \sqrt{1 - w} exp ( - ⅈ α w ) = {( \frac{i}{α} \frac{\partial }{\partial α} )}^{m} \int ⅆ w \sqrt{1 - w} exp ( - ⅈ α w ) . \qquad ( 52 )$$

Eqs. (49), (50), and (52) are combined to realize, for L=4, the following approximation for the integral in Eq. (48) which is valid for W∈[0,1]:

$${\int }_{1}^{cos β} ⅆ w \sqrt{1 - {w}^{2}} exp ( - ⅈα w ) = {α}^{- 5} \{ 0.166667 exp ( - ⅈ α u ) \sqrt{1 - w} . [ ⅈ 2.0 ( - 0.030585 {w}^{4} + 0.133654 {w}^{3} - 0.358614 {w}^{2} + 1.49819 w + 3.0 ) {α}^{4} + ( - 0.275266 {w}^{3} + 0.904993 {w}^{2} - 1.69 w + 4.23901 ) {α}^{3} + ⅈ ( - 0.963433 {w}^{2} + 2.12485 w - 2.22014 ) {α}^{2} - ( 2.40858 w - 2.70556 ) α - ⅈ 3.61287 ] - ⅈ 0.443113 exp ( - ⅈ α ) {α}^{- 1 / 2} F [ 0.797585 \sqrt{α ( 1 - w )} ] ( 4.0 {α}^{4} - ⅈ 1.49847 {α}^{3} + 0.499087 {α}^{2} + ⅈ 0.139995 α - 1.70312 ) \} + ɛ , \qquad ( 53 )$$

where |ε|<10⁻⁵ for all values of α and w∈[0,1]. FIG. 9 illustrates a Log-Log plot of ε vs α for various values of w∈[0,1]. The error curves 1102, 1103, 1104 and 1105 correspond to the values of w where the maximum error η occurs in FIG. 8 at points 1102, 1103, 1104 and 1105 on the w axis, respectively. Note that the various floating-point numbers in Eq. (53) come from the results of the curve fitting to obtain the coefficients fₘ in Eq. (49). Eq. (53) can be extended to values of w<0 by computing its complex conjugate.

Therefore, the preferred embodiment in accordance with the present invention, the paraxially defocused TCC (i.e. for NA≦0.5) of Eq. (44), i.e.:

$$T ( {u}^{′} , {u}^{″} ) = - \frac{exp ( - ⅈ π b )}{ⅈ 2 π \vert a \vert} {\sum }_{j = 1}^{N} {ρ}_{j} [ J ( 2 π {ρ}_{j} \vert a \vert , {ϕ}_{0} + {ϕ}_{2}^{( j )} ) - J ( 2 π {ρ}_{j} \vert a \vert , {ϕ}_{0} + {ϕ}_{1}^{( j )} ) ] , \qquad ( 54 a )$$

can now be computed analytically, within an error of 10⁻⁵, where the integrals J are expressed by the following expression, for L=4, as:

$$J ( α , β ) = sin β exp ( - ⅈ α cos β ) + ⅈ {αα}^{- 5} \{ 0.166667 exp ( - ⅈ α u ) \sqrt{1 - w} \cdot [ ⅈ 2.0 ( - 0.030585 {w}^{4} + 0.133654 {w}^{3} - 0.358614 {w}^{2} + 1.49819 w + 3.0 ) {α}^{4} + ( - 0.275266 {w}^{3} + 0.904993 {w}^{2} - 1.69 w + 4.23901 ) {α}^{3} + ⅈ ( - 0.963433 {w}^{2} + 2.12485 w - 2.22014 ) {α}^{2} - ( 2.40858 w - 2.70556 ) α - ⅈ 3.61287 ] - ⅈ 0.443113 exp ( - ⅈ α ) {α}^{- 1 / 2} F [ 0.797585 \sqrt{α ( 1 - w )} ] ( 4.0 {α}^{4} - ⅈ 1.49847 {α}^{3} + 0.499087 {α}^{2} + ⅈ 0.139995 α - 1.70312 ) \} \qquad ( 54 b )$$

where α=2πρⱼ|a|, a=−NA²z(u′−u″)/λ, and β=φ₀+φ₂^{(j)} and φ₀+φ₁^{(j)} at the endpoints of the N arcs of the region of integration, which is the intersection of the source and offset pupil functions. Similar analytical expressions for TCC can be derived having greater accuracy by including additional terms in a substantially monotonic approximation of Eq. (48) (e.g. by using larger values of L in Eq. (49) or similar expansions of Eq. (48)). Thus, in accordance with the present invention, these TCCs can be obtained with a relatively small number of arithmetic operations relative to numerical integrations that are used in current simulators. Accordingly, the image intensities can likewise be computed with improved speed and accuracy.
6. Extension to High NA

Eq. (38) dictates the nonparaxial (i.e. where NA is greater than about 0.5) phase behavior of the defocused pupil function P_{D}. Because of the square root in the exponential, a simple, analytical expression, such as that found in Eq. (53), which is the result of a paraxial approximation, is not possible. Nevertheless, there is a simple algebraic transformation of the electric field expression in Eq. (1), that depends only on the spatial (x) coordinate and not the spatial frequency, that corrects for the phase errors introduced by the paraxial approximation (see, for example, Forbes et al., “Algebraic corrections for paraxial wave fields,” J. Opt. Soc. Am. A, Vol. 14, No. 12, pp. 3300-3315, Dec. 1997). By treating this nonparaxial correction as an algebraic transformation that is independent of spatial frequency, the values of the TCCs will not change.

The nonparaxial correction to the paraxial electric field intensity is given by the following transformation: Let Iₚ(x,z) be the paraxial intensity, at a point x on the image plane, and z is the defocus amount. Then the nonparaxial intensity I(x,z) (i.e. for all NA including NA greater than about 0.7) can be approximated by

$$\begin{matrix}I ( x , z ) = {[ 1 + {NA}^{2} {g ( x . z )}^{2} ]}^{- 2} {I}_{P} ( {[ 1 + {NA}^{2} {g ( x , z )}^{2} ]}^{- 1 / 2} x , z ) , & ( 55 a ) \\ g ( x , z ) = \frac{\vert x \vert / ( NAz )}{1 + \frac{9 {λ}^{4}}{256 {π}^{8} {NA}^{8} {z}^{4}}} & ( 55 b )\end{matrix}$$

The factor 1+NA²g(x,z)² in square brackets is analogous to an obliquity term that is absent in the paraxial approximation. The denominator on the right-hand side of Eq. (55b) corresponds to a switching function that turns off the correction in the focal plane.
7. Extension to Aberrations

A wave aberration may be represented as a phase term of polynomials, such as Zernike polynomials, across the pupil. For the purposes of lithography modeling in a production semiconductor manufacturing environment, these aberrations are typically small, for example, less than about 1-3% of the illumination wavelength λ. It is convenient to express the aberrations as an exponential P_{A} of a phase term across the pupil as:

$${P}_{A} ( u ) = exp [ ⅈ2π {ɛ}_{w} {\sum }_{q = 1}^{Q} {ζ}_{q} {Z}_{q} ( u ) ] , \qquad ( 56 )$$

where Z_{q} is the q^{th} Zernike polynomial, ζ_{q} is the corresponding Zernike coefficient, Q is typically 37 in most lithographic applications, and ε_{w}, which is a small, dimensionless number that represents the order of magnitude of the wavefront error (for example, as discussed above, ε_{w} may be on the order of 0.01λ). Because these aberrations are considered small compared to the wavelength, the exponential pupil function P_{A} can be Taylor expanded with respect to ε_{w} out to, say, O(ε_{w}²), to yield:

$${P}_{A} ( u ) \approx 1 + ⅈ2π {ɛ}_{w} {\sum }_{q = 1}^{Q} {ζ}_{q} {Z}_{q} ( u ) - {[ 2 π {\sum }_{q = 1}^{Q} {ζ}_{q} {Z}_{q} ( u ) ]}^{2} {ɛ}_{w}^{2} . \qquad ( 56 a )$$

Typically, aberrations are combined with a defocus term for simulation purposes in order to explore degradation of process window that a particular set of aberrations may cause. The combined pupil function is multiplicative; that is, it takes the form P(u)=P_{A}(u)P_{D}(u). Aberrations in a lens will result in a lack of a single geometrical focus, and increases the size of the diffraction “blur” in the image. This degrades the ability to image critical features over a wide range of focus and dose conditions, which is what we mean by the degradation of the process window. In accordance with the present invention, two methods are presented for analytically computing the aberration pupil function P_{A}.

In a first embodiment, note that the phase term (i.e.

$$( i . e . π \frac{z}{λ} N {A}^{2} {u}^{2} )$$

of the paraxial defocus pupil function of Eq. (39) is mathematically equivalent to the fourth Zernike polynomial Z₄, more specifically, is a quadratic function of u, and thus can be considered as an effective aberration. That is, the paraxial defocus term can be combined with the (ζ₄ aberration coefficient, thus containing the defocus amount z as a component. Substituting the series expansion of Eq. (56a) into the TCC expression in Eq. (5) results in a series of terms involving integrals of the form

$${Ψ}_{min} = {\int }_{D ⋂ S} {ⅆ}^{2} {σσ}_{x}^{m} {σ}_{y}^{n} . \qquad ( 57 )$$

For example, if Q=8, then there are 21 such terms. Again, the double integrals defined by Eq. (57) can be simplified by using Stokes' Theorem (see Eq. (42)), into a single integral around the boundary of the TCC integration region:

$${Ψ}_{min} = {∮}_{\partial ( D ⋂ S )} ( ⅆ {σ}_{y} \frac{{σ}_{x}}{m + 1} - ⅆ {σ}_{x} \frac{{σ}_{y}}{n + 1} ) {σ}_{x}^{m} {σ}_{y}^{n} . \qquad ( 58 )$$

As in the previous case, the contour is made up of N circular arcs, the p^{th} arc having center (uₚ,vₚ) and radius ρₚ. When the path is parametrized as follows:
σₓ=uₚ+ρₚ cos φ,
σₓ=vₚ+ρₚ sin φ, (59)
with φ∈[0,2π], and the angle φ of the endpoint is measured relative to the horizontal axis, then the integral in Eq. (58) can be evaluated as a sum over functions defined by a single integral:

$${Ψ}_{min} = \frac{1}{2} {\sum }_{p = 1}^{N} {\sum }_{k = 0}^{m} {\sum }_{l = 0}^{n} ( \begin{matrix}m \\ k\end{matrix} ) ( \begin{matrix}n \\ l\end{matrix} ) {u}_{p}^{m - k} {v}_{p}^{n - l} {ρ}_{p}^{k + l} \times {\int }_{{ϕ}_{1}^{( p )}}^{{ϕ}_{2}^{( p )}} ⅆ ϕ [ \frac{{ρ}_{p}^{2} {cos}^{2} ϕ + {ρ}_{p} {u}_{p} cos ϕ}{m + 1} + \frac{{ρ}_{p}^{2} {sin}^{2} ϕ + {ρ}_{p} {v}_{p} sin ϕ}{n + 1} ] {cos}^{k} {ϕsin}^{l} ϕ . \qquad ( 60 )$$

It turns out that the integrals in Eq. (60) can be expressed in terms of incomplete beta functions:

$${\int }_{{ϕ}_{1}}^{{ϕ}_{2}} ⅆ {ϕsin}^{K} {ϕcos}^{L} ϕ = {B}_{{sin}_{{ϕ}_{2}}^{2}} ( \frac{K + 1}{2} , \frac{L + 1}{2} ) - {B}_{{sin}_{{ϕ}_{1}}^{2}} ( \frac{K + 1}{2} , \frac{L + 1}{2} ) , \qquad ( 61 )$$

where

$${B}_{z} ( x , y ) = {\int }_{0}^{z} ⅆ t {{t}^{x - 1} ( 1 - t )}^{y - 1} \qquad ( 62 )$$

is the incomplete beta function. This function is well-known in the mathematical literature and algorithms exist that compute its value using only a few arithmetic operations. Such an expansion of the aberration pupil function in terms of incomplete beta functions has been considered previously for one-dimensional (1D) geometries (see, for example, Steel, W. H, “Effects of Small Aberrations on the Images of Partially Coherent Objects,” J. Opt. Soc. Am., Vol. 47, No. 5, pp. 405-413 (1957)), but not for two-dimensional (2D) geometries. In accordance with the present invention, the form of Eq. (61) provides an analytical solution for the aberration pupil function P_{A} for general 2D geometries. This pupil function can be multiplied with the defocused pupil function P_{D}, or for example P_{DP} as provided in Eq. (39) of a preferred embodiment, and the resulting TCC computed, for example as in Eq. (54a), can be used to provide an analytical expression for image intensity that includes aberrations, and that has small error. However, this solution is applicable to a limited range of defocus values, limited by the small value of ε_{w} that is assumed.

More preferrably, in a second embodiment for computing aberrated images, the paraxial defocus term P_{DP} is treated separately from the aberration term P_{A} and the argument in the exponential of P_{DP} is not assumed to be small (i.e. for z larger than the wavelength λ). In accordance with the present invention, the aberration pupil function P_{A} is Taylor expanded to 2^{nd} order in ε_{w} in accordance with Eq. (56a), but the paraxial defocus pupil function P_{DP} (see Eq. (39)) is kept as is. Substituting the Taylor expansion of P_{A} into the TCC integral of Eq. (5), integrals of the form:

$$\begin{matrix}{Ψ}_{min} = {\int }_{D ⋂ S} {ⅆ}^{2} σ {σ}_{x}^{m} {σ}_{y}^{n} exp ( - ⅈ2π a \cdot σ ) \\ = {( \frac{ⅈ}{2 π} )}^{m + n} \frac{{\partial }^{m}}{\partial {a}_{x}^{m}} \frac{{\partial }^{n}}{\partial {a}_{y}^{n}} {\int }_{D ⋂ S} {ⅆ}^{2} σ exp ( - ⅈ2π a \cdot σ ) .\end{matrix} \qquad ( 63 )$$

are obtained, where a=−NA²z(u′−u″)/λ.

The integral on the 2^{nd} line of Eq. (63) has the same form as the TCC integral of Eq. (40) and therefore, Ψₘₙ is expressed explicitly in terms of derivatives of the analytical functions of the form previously derived, for example as in Eqs. (54a) and (54b), whose integrals also have known analytical solutions. Therefore, the aberration pupil function P_{A} is now expressed in terms of analytical functions which is then, in accordance with the present invention, multiplied with the paraxial defocused pupil function P_{DP} to obtain an integrand for the TCC integral that includes aberrations.

8. Energy Conservation, Vector Effects, and Air/Resist Interfaces

In the simulation of the very high-NA (NA>0.7) systems in use at the latest technology nodes, other physical effects such as obliquity due to power conservation constraints, vector diffraction effects, and the effects of the resist layer complicate the analytical structure of the Hopkins' TCC integral. These three effects, however, have the common property that they are essentially pupil apodizations; that is, they are amplitude variations across the pupil. The functional forms that describe these variations each would make the TCC integral impossible to simplify in an exact form. For example, the propagation of the light into the resist from air produces the following pupil amplitude function:

$${P}_{Ap} ( u ) = \frac{2 \sqrt{1 - N {A}^{2} {u}^{2}}}{\sqrt{1 - N {A}^{2} {u}^{2}} + \sqrt{1 - N {A}^{2} {u}^{2} / {n}^{2}}} , \qquad ( 64 )$$

where n is the index of refraction of the resist. Nevertheless, as with the aberration term, such apodizations can be considered as corrections to the unapodized image, so that the apodization terms can be Taylor expanded for small spatial frequencies. Thus, in a preferred embodiment of the present invention, an apodization pupil function P_{AP}, which can be expressed as an amplitude factor, would then be multiplied with the paraxial defocused pupil function P_{D}, or P_{DP} to obtain a pupil function that includes apodizations.

9. Implementation in Computer Software

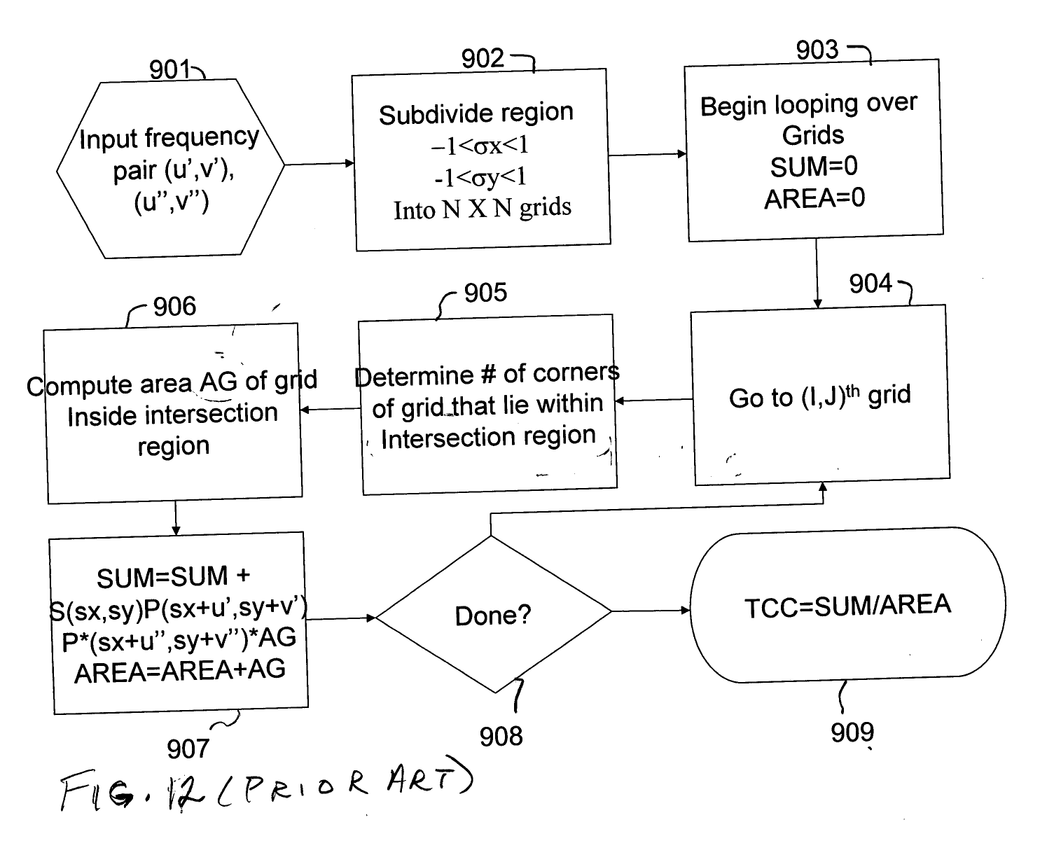

The method of simulating the image intensity in accordance with the present invention may be implemented in machine readable code (i.e. software or computer program product) and performed on a computer, such as, but not limited to, the type illustrated in FIG. 10, wherein a central processing unit (CPU) 1300 is connected by means of a bus, network or other communications means 1310 to storage devices such as disk 1301, or memory 1302, as well as connected to various input/output devices, such as a display monitor 1304, a mouse 1303, a keyboard 1305, and other I/O devices 1306 capable of reading and writing data and instructions from machine readable media 1308 such as tape or compact disk (CD). In addition, there may connections via a network 1310 to other computers and devices, such as may be exist a network of such devices, e.g. the Internet. Software to perform the method steps to obtain an image may be implemented as a program product and stored on machine readable media 1308.

FIG. 11 illustrates a typical flowchart of a method for computing images according to the Hopkins model. At step 101, characteristics of the imaging system are provided, such as the illumination wavelength λ, the numerical aperture NA, the partial coherence factor σ, the amount of defocus z and other parameters of the imaging system and process. A mask region to be imaged is provided (step 102) where typically the mask region is assumed to be periodic at a pitch pₓ,p_{y} in the x- and y-directions, respectively for a 2D mask. The spacing Δu in the spatial frequency domain is determined by Δu=λ/pNA, which may be different in the x- and y-directions depending on the pitch p (see Eqs. (7) and (8) above). Next the summation limits from Eqs. (11) and (14) are determined (step 104). Other imaging parameters may be optionally provided, such as, for example lens aberrations (step 105). The TCCs of Eq. (5) are computed (step 106), typically by a numerical method to be described in more detail below. As an example, for a 40 μm² mask cell, simulated at λ=193 nm, there are about 3.6 million TCC integrals to compute. Mask parameters, for example in the form of polygon shapes, are provided (step 107). The Fourier spectrum of the image intensity for those polygons is computed (step 108), for example as disclosed in U.S. patent application Ser. No. 10/353,900, filed on Jan. 28, 2003, which is commonly assigned to the Assignee of the present application. Optionally, the image can be simulated over a subset of the mask cell region, for example, one might be interested only in the CD of a line in a particular portion of the cell (step 109). Then the image intensity is computed over the simulation region according to Eqs. (14) and (11).

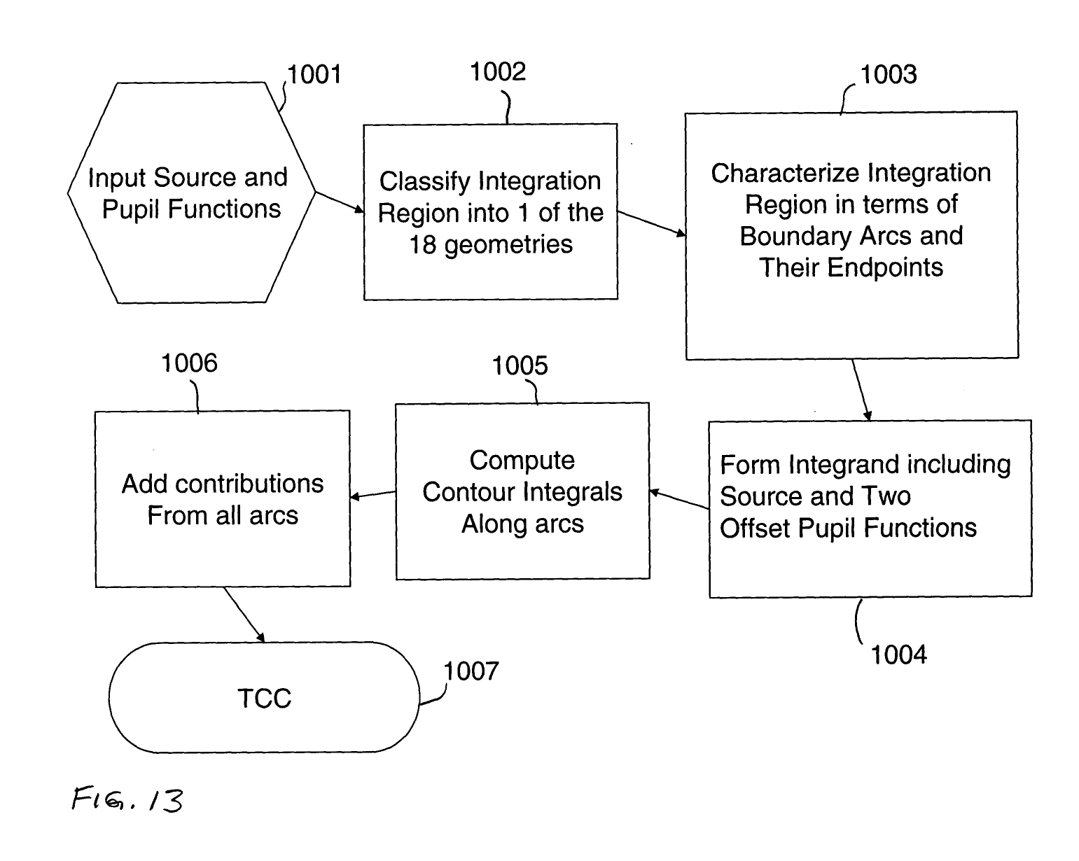

More specifically, the conventional method for computing TCCs is illustrated in FIG. 12. First a pair of offset pupil functions are provided, by entering the center coordinates in scaled spatial frequency source coordinate space (step 901). Each offset pupil function represents a coupling between rays originating from different source points passing through the pupil. The region of integration (typically, between −1<σₓ<1 and −1<σ_{y}<1) is divided into an N×N grid block (step 902). For each grid block (step 903), the location of the corners of each grid block with respect to the intersection regions of the source function and the offset pupil functions are determined (step 905). Based on the location of the grid block corners, the area of the grid block within the integration region is determined (e.g. estimated) (step 906), and the TCC integral of Eq. (5) is computed by numerical summation of the source-weighted pupil functions over all grid blocks (907, 908), and scaled by the area of the integration region (step 909). Note that the accuracy of the integration by the prior art method is dependent on how fine the gridding is, but the computation time increases significantly as more grid blocks are used.

A flow chart of an embodiment in accordance with the present invention is illustrated in FIG. 13. For each TCC, a pair of pupil functions having center coordinates offset in source coordinate space relative to the center of the source function (step 1001). The intersection region of the offset pupil and source functions are identified as the region of integration and classified according to one of the 18 geometries discussed in subsection 3 above (step 1002). The boundary arcs of the intersection region are then characterized in terms of their intersection points (i.e. the arc endpoints) and the angular coordinates corresponding to the arc endpoints are determined (step 1003). Next, the form of the TCC integrand is determined by approximating the pupil function by at least a paraxial defocus term times a polynomial in the σₓ,σ_{y} coordinates (step 1004). The contour integrals for the expansion of the pupil functions are determined (for example, using Eq. (54b)) (step 1005), and then the contributions from all arcs are added (step 1006) and the TCC, in a form such as Eq. (54a), are computed (step 1007). If aberrations are to be included, an aberration pupil function is preferably obtained by an Taylor expansion of a deviation from a spherical lens, in the form of analytical functions of the form in Eq. (63) and used to modify the integrand in step 1004. Additionally, step 1004 could be further modified to include apodization pupil functions as additional factors.

Although the present invention and its advantages have been described in detail, it should be understood that various changes, substitutions and alterations can be made herein without departing from the spirit and scope of the invention as defined by the appended claims.

1. A method of simulating an image of a patterned mask having a mask function in the spatial frequency domain, the image to be formed by a projection system having a defocus amount z along an optical axis, the projection system including pupil optics, the method comprising:
providing a source function having a center spatial frequency coordinate;
providing a first paraxial pupil function of the pupil optics at a first offset relative to said center spatial frequency coordinate and providing a second paraxial pupil function of the pupil optics at a second offset relative to said center spatial frequency coordinate;
forming an integrand comprising a product of functions including said source function, said first paraxial pupil function, and said second paraxial pupil function;
defining an integration region spanning the intersection of said source function with said first and second paraxial pupil functions, said integration region having a boundary comprising a finite number of arcs;
integrating said integrand for each of said finite number of arcs to obtain a finite number of contour integrals each corresponding to one of said finite number of arcs, wherein each of said finite number of contour integrals comprises an analytical solution; and
determining a transmission cross-coefficient (TCC) comprising a sum of said finite number of contour integrals.

2. The method of claim 1 wherein said first and second paraxial pupil functions each has a phase term that is approximated by a second order Taylor expansion.

3. The method of claim 1 wherein each of said arcs are circular arcs having a subtended angle φ relative to the center of the corresponding circle of said arc.

4. The method of claim 3 wherein said integrand is parameterized in terms of a square root of one plus the cosine of said subtended angle φ, and wherein said square root is approximated by an expansion having an error term, wherein said expansion has a finite number of terms L, wherein L is sufficiently large that said error term is smaller than a predetermined error tolerance.

5. The method of claim 4, wherein said expansion has L parameters fₘ, where m ranges from 1 to L, said parameters determined by a curve fit to the square root of one plus the cosine of said subtended angle φ.

6. The method of claim 5 wherein said parameters fₘ comprise a polynomial expansion of the form
$$( 1 + {\sum }_{m = 1}^{L} {{f}_{m} ( cos ϕ )}^{m} ) .$$

7. The method of claim 6 wherein said finite number of terms L is 4.

8. The method of claim 1 wherein the projection system has a numerical aperture (NA) between about 0.5 to 0.7.

9. The method of claim 1 further comprising the step of determining image intensity in accordance with a Hopkins model using said TCC integral.

10. The method of claim 9 wherein the projection system has a numerical aperture (NA) greater than about 0.7, and wherein said image intensity is determined at a coordinate \vec{x} orthogonal to the optical axis, and said method further comprises dividing said coordinate \vec{x} by the square root of a nonparaxial correction factor (1+NA²g(\vec{x}, z)²) and dividing said image intensity by the square of said nonparaxial correction factor, wherein
$$g ( {x}^{->} , z ) = \frac{\vert {x}^{->} \vert}{( N A z ) ( 1 + \frac{9 {λ}^{4}}{256 {π}^{8} N {A}^{8} {z}^{4}} )}$$
for an illumination comprising a wavelength of λ.

11. The method of claim 1 further comprising determining an aberration pupil function comprising an exponential of a phase term, said phase term expressed by a closed form polynomial series with respect to a deviation ε_{w} from a spherical lens, wherein said exponential is Taylor expanded in terms of said deviation ε_{w} to a specified order, wherein said step of forming an integrand further comprises multiplying each of said first and second paraxial pupil functions by said aberration pupil function.

12. The method of claim 11 wherein said closed form polynomial series comprises Zernike polynomials.

13. The method of claim 1 further comprising determining an apodization pupil function comprising a factor representing amplitude variations across the pupil, and wherein said step of forming an integrand further comprises multiplying each of said first and second paraxial pupil function by said apodization pupil function.

14. The method of claim 13 wherein said wherein the projection system has a numerical aperture (NA) greater than about 0.7.

15. A computer program product comprising computer readable storage medium having stored therein computer readable instructions executable by the computer for causing a computer to perform method steps for simulating an image of a patterned mask having a mask function in the spatial frequency domain, the image to be formed by a projection system having a defocus amount z along an optical axis, the projection system including pupil optics, the method steps comprising:
providing a source function having a center spatial frequency coordinate;
providing a first paraxial pupil function of the pupil optics at a first offset relative to said center spatial frequency coordinate and providing a second paraxial pupil function of the pupil optics at a second offset relative to said center spatial frequency coordinate;
providing an integrand comprising a product of functions including said source function, said first paraxial pupil function, and said second paraxial pupil function;
defining an integration region spanning the intersection of said source function with said first and second paraxial pupil functions, said integration region having a boundary comprising a finite number of arcs;
integrating said integrand for each of said finite number of arcs to obtain a finite number of contour integrals each corresponding to one of said finite number of arcs, wherein each of said finite number of contour integrals comprises an analytical solution; and
determining a transmission cross-coefficient (TCC) comprising a sum of said finite number of contour integrals.

16. The computer program product of claim 15 wherein said first and second paraxial pupil functions each has a phase term that is approximated by a second order Taylor expansion.

17. The computer program product of claim 15 wherein each of said arcs are circular arcs having a subtended angle φ relative to the center of the corresponding circle of said arc.

18. The computer program product of claim 17 wherein said integrand is parameterized in terms of a square root of one plus the cosine of said subtended angle φ, and wherein said square root is approximated by an expansion having an error term, wherein said expansion has a finite number of terms L, wherein L is sufficiently large that said error term is smaller than a predetermined error tolerance.

19. The computer program product of claim 18, wherein said expansion has L parameters fₘ, where m ranges from 1 to L, said parameters determined by a curve fit to the square root of one plus the cosine of said subtended angle φ.

20. The computer program product of claim 19 wherein said parameters fₘ comprise a polynomial expansion of the form
$$( 1 + {\sum }_{m = 1}^{L} {{f}_{m} ( cos ϕ )}^{m} ) .$$

21. The computer program product of claim 20 wherein said finite number of terms L is 4.

22. The computer program product of claim 15 wherein the projection system has a numerical aperture (NA) between about 0.5 to 0.7.

23. The computer program product of claim 15 wherein said method steps further comprise the step of determining image intensity in accordance with a Hopkins model using said TCC integral.

24. The computer program product of claim 23 wherein the projection system has a numerical aperture (NA) greater than about 0.7, and wherein said image intensity is determined at a coordinate \vec{x} orthogonal to the optical axis, and said method steps further comprise dividing said coordinate \vec{x} by the square root of a nonparaxial correction factor (1+NA²g(\vec{x},z)²) and dividing said image intensity by the square of said nonparaxial correction factor, wherein
$$g ( {x}^{->} , z ) = \frac{\vert {x}^{->} \vert}{( N A z ) ( 1 + \frac{9 {λ}^{4}}{256 {π}^{8} N {A}^{8} {z}^{4}} )}$$
for an illumination
comprising a wavelength of λ.

25. The computer program product of claim 15 wherein said method steps further comprise providing an aberration pupil function comprising an exponential of a phase term, said phase term expressed by a closed form polynomial series with respect to a deviation ε_{w} from a spherical lens, wherein said exponential is Taylor expanded in terms of said deviation ε_{w} to a specified order, wherein said step of providing an integrand further comprises multiplying each of said first and second paraxial pupil functions by said aberration pupil function.

26. The computer program product of claim 25 wherein said closed form polynomial series comprises Zernike polynomials.

27. The computer program product of claim 15 wherein said method steps further comprise providing an apodization pupil function comprising a factor representing amplitude variations across the pupil, and wherein said step of providing an integrand further comprises multiplying each of said first and second paraxial pupil function by said apodization pupil function.

28. The computer program product of claim 27 wherein said wherein the projection system has a numerical aperture (NA) greater than about 0.7.
